(19) United States
(12) Patent Application Publication
(10) Pub. No.: US 2026/0100041 A1
(43) Pub. Date: Apr. 9, 2026

(54) SENSOR STREAM SELECTION FOR MULTI-MODAL LANGUAGE MODELS FOR AUTONOMOUS MACHINES AND APPLICATIONS

(71) Applicant: NVIDIA CORPORATION, Santa Clara, CA (US)

(72) Inventors: Rajath Bellipady Shetty, Sunnyvale, CA (US); Niral Lalit Pathak, Santa Clara, CA (US); Ratin Kumar, Cupertino, CA (US)

(21) Appl. No.: 18/905,189

(22) Filed: Oct. 3, 2024

(51) Int. Cl. G06V 20/50; G05B 13/02; G06F 40/40; G06T 3/40; G06T 15/00; G06V 10/25; G06V 10/80

(52) U.S. Cl. CPC G06V 20/50; G05B 13/0265; G06F 40/40; G06T 3/40; G06T 15/00; G06V 10/25; G06V 10/803

(57) ABSTRACT

In various examples, multiple sensors of an ego-machine may be used to generate corresponding streams of sensor data, and a multi-modal language model may be used to select a stream from among multiple streams to evaluate for a given detection task. Taking image data generated using multiple exterior cameras as an example, a vision language model (VLM) may be prompted to evaluate an image from each camera (e.g., resized to a designated resolution supported by the VLM) and identify a relevant camera for a designated task. The VLM may be prompted at a designated frame rate, and once the VLM identifies a camera or corresponding video stream, the VLM may be prompted with a (e.g., subsequent, higher resolution) frame of image data from the identified camera to perform one or more subsequent tasks (e.g., a designated detection task, identify an ROI within the higher resolution frame of image data, etc.).

### BACKGROUND

In modern vehicles and other ego-machines, deep neural networks (DNNs) and computer vision (CV) techniques are often used to provide a range of advanced functionalities. For example, DNNs and CV may be used by autonomous and semi-autonomous vehicles for tasks such as object detection, traffic sign recognition, driver and occupant monitoring, and trajectory planning, among other things.

Recent research has begun exploring the use of large language models (LLMs) and vision-language models (VLMs) to support autonomous and semi-autonomous vehicles. However, the performance of these models can be significantly impacted by the computational resources available and the quality of the input data they receive. When operating in environments with limited computational power (e.g., in-vehicle computing), these models often struggle to localize and interpret relevant information like text or objects with sufficient accuracy in real time. For example, these models often miss relevant information in extremely high-resolution images, resulting in inaccuracies and wasted computational resources. However, reducing the resolution of the input image can also lead to performance issues, as the reduced detail in low-resolution images can obscure important information (e.g., compressing a wide-angle image of a road sign can reduce the size of the text on the road sign, making it hard for a VLM to read and understand), again resulting in inaccuracies and wasted computational resources.

Furthermore, systems such as autonomous and semi-autonomous vehicles with multiple cameras or other sensors often struggle to efficiently process the vast amounts of sensor data they generate. These systems effectively generate, transmit, and process sensor data continuously, but not all sensor data is relevant or useful for tasks such as navigation, obstacle detection, or driver assistance. Continuously processing sensor data from all sensors wastes computational resources that could be used for other processing tasks, which can increase latency or otherwise inhibit the system.

Moreover, processing and transmitting high-quality sensor data consumes limited on-device and network bandwidth. In an example application, an ego-machine may include ten cameras between 2-10 megapixels, each connected to an on-vehicle system-on-chip (SoC) with an image signal processor (ISP) that process raw image data (e.g., performing tasks such as color correction and noise reduction), a video encoder that encodes (e.g., processed) images from any given camera into a compressed video stream (e.g., encoded using the H.264 video compression standard), and a networking or communication interface that serializes the video stream or transfers it over a network connection to some other device (e.g., a server hosting a VLM) for processing. However, generating and streaming this compressed but high-resolution data can quickly consume the available bandwidth, especially when multiple high-resolution cameras are active simultaneously. As a result, processing and transmitting high-quality sensor data can result in delays, lost data, and misalignments in timing between multiple video feeds, especially in conditions with limited or unstable network connections. These issues can compromise the real-time processing capabilities of the system, potentially impacting system functionality.

As such, there is a need for improved techniques for handling sensor data for exterior and interior monitoring and sensing tasks.

### SUMMARY

Embodiments of the present disclosure relate to sensor stream selection, iterative input refinement, and/or tokenized data streaming for multi-modal language models.

For example, multiple sensors of an ego-machine such as a vehicle may be used to generate corresponding streams of sensor data, and a multi-modal language model may be used to select a stream to evaluate for a given detection task. Taking image data generated using multiple exterior cameras as an example, a vision language model (VLM) may be prompted to evaluate one or more frames of image data from each camera or an identified sub-region of interest thereof (e.g., resized to a designated resolution supported by the VLM) and identify a relevant camera for a designated task (e.g., using a text prompt such as “Can one of the cameras see a road sign?” or “is a road sign visible in any of these images?”). The VLM may be prompted at a designated frame rate, and once the VLM identifies a camera or corresponding video stream, the VLM may be prompted with a (e.g., subsequent, higher resolution) frame of image data from the identified camera to perform one or more subsequent tasks (e.g., a designated detection task, identify a region of interest (ROI) within the higher resolution frame of image data, etc.).

In some embodiments, a multi-modal language model such as a VLM may be iteratively prompted to identify and/or refine an ROI for a designated detection task. For example, an initial prompt may broadly focus the VLM on identifying one or more ROIs within an image. After identifying an initial ROI, the VLM may be prompted to refine the ROI, for example, by prompting the VLM to evaluate the initial ROI and identify an ROI with more specific content than the initial prompt did. Additionally or alternatively, some embodiments may iteratively refine an ROI over multiple frames generated over time until a measure of confidence that the identified ROI contains the designated content meets a designate threshold, upon which, the multi-modal language model may be prompted to perform the detection task on the identified ROI.

In some embodiments, to reduce the bandwidth used to support one or more inferences, the multi-modal language model may be split up and hosted by multiple devices. For example, a modality (e.g., vision, audio) encoder and/or projector of the multi-modal language model (e.g., VLM) may be hosted on one device (e.g., an in-vehicle SoC) that encodes raw sensor data into corresponding tokens and streams the tokens to a second device (e.g., an external graphic processing unit (GPU) or artificial intelligence (AI) accelerator) that hosts an inference server and a language model (LM) of the multi-modal language model. The LM may return a response indicating the result(s) of the requested detection task, and the response may be used to take some responsive action (e.g., control one or more operations of an ego-machine). Encoding sensor data into tokens and streaming the tokens instead of the (e.g., compressed) sensor data uses less bandwidth and improves data synchronization (e.g., reduces misalignments in timing between multiple sensor data feeds being processed substantially simultaneously), among other benefits.

As such, the present techniques may be used to increase the accuracy and performance of driver monitoring, occupant monitoring, environmental text perception, and/or other tasks that use VLMs or other multi-modal language models.

### BRIEF DESCRIPTION OF THE DRAWINGS

The present systems and methods for sensor stream selection, iterative input refinement, and/or tokenized data streaming for multi-modal language models are described in detail below with reference to the attached drawing figures, wherein:

FIG. 1 is a block diagram illustrating an example detection pipeline, in accordance with some embodiments of the present disclosure;

FIG. 2 is a flow diagram showing a method for sensor stream selection, in accordance with some embodiments of the present disclosure;

FIG. 3 is a flow diagram showing a method for iterative input refinement, in accordance with some embodiments of the present disclosure;

FIG. 4 is a block diagram illustrating an example multi-modal language model, in accordance with some embodiments of the present disclosure;

FIG. 5 is a flow diagram showing a method for sensor selection using a multi-modal language model, in accordance with some embodiments of the present disclosure;

FIG. 6 is a flow diagram showing a method for identifying one or more regions of interest using a multi-modal language model, in accordance with some embodiments of the present disclosure;

FIG. 7 is a flow diagram showing a method for streaming a tokenized representation of sensor data, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed relating to sensor stream selection, iterative input refinement, and/or tokenized data streaming for multi-modal language models such as vision language models (VLMs). The present techniques may be used for interior and/or exterior detection tasks such as driver monitoring, occupant monitoring, and/or environmental text perception, and may be used by autonomous vehicles, semi-autonomous vehicles, robots, and/or other object or machine types.

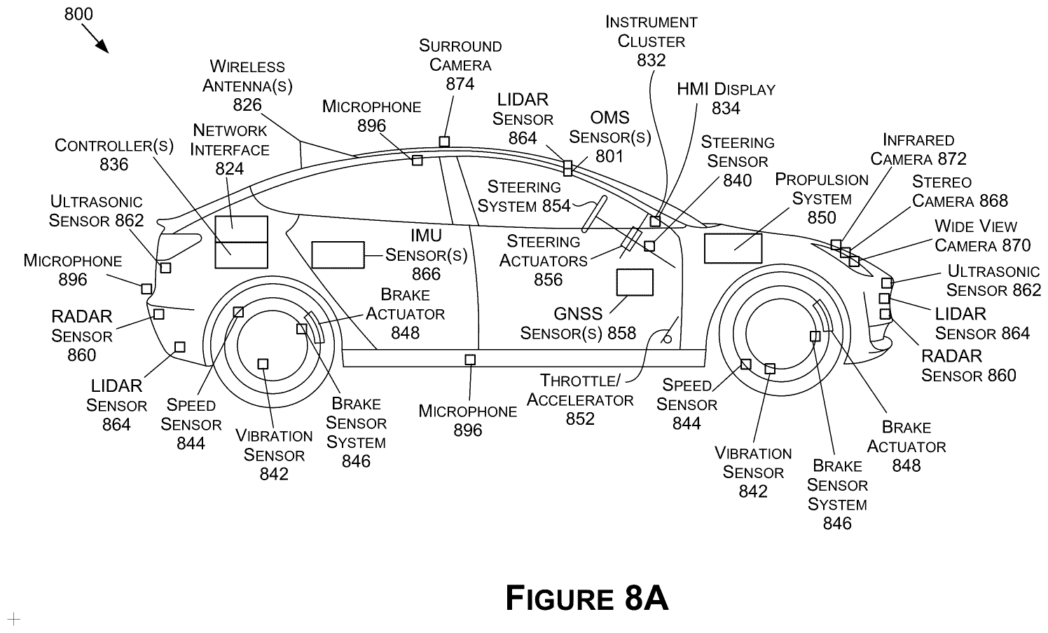

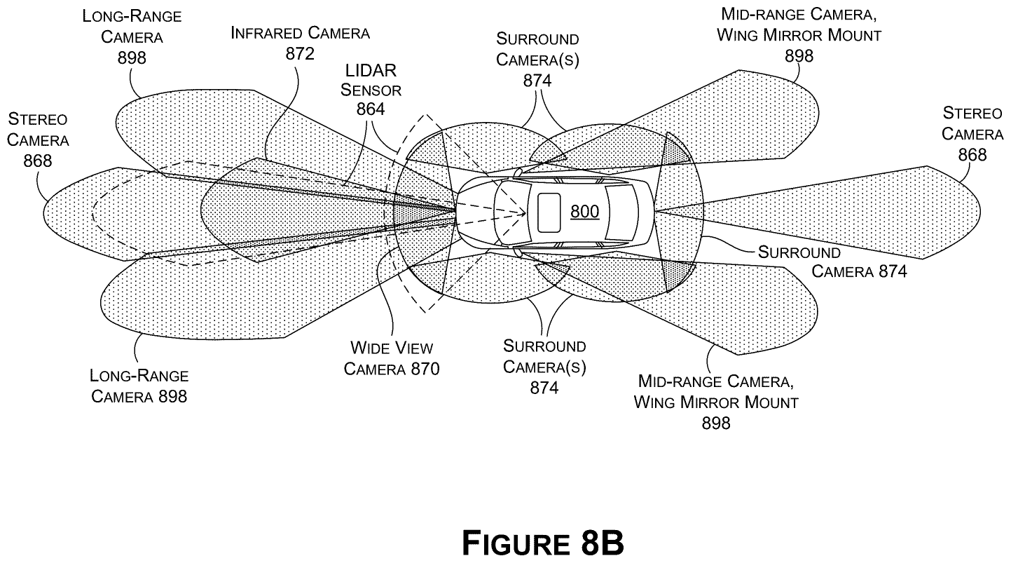

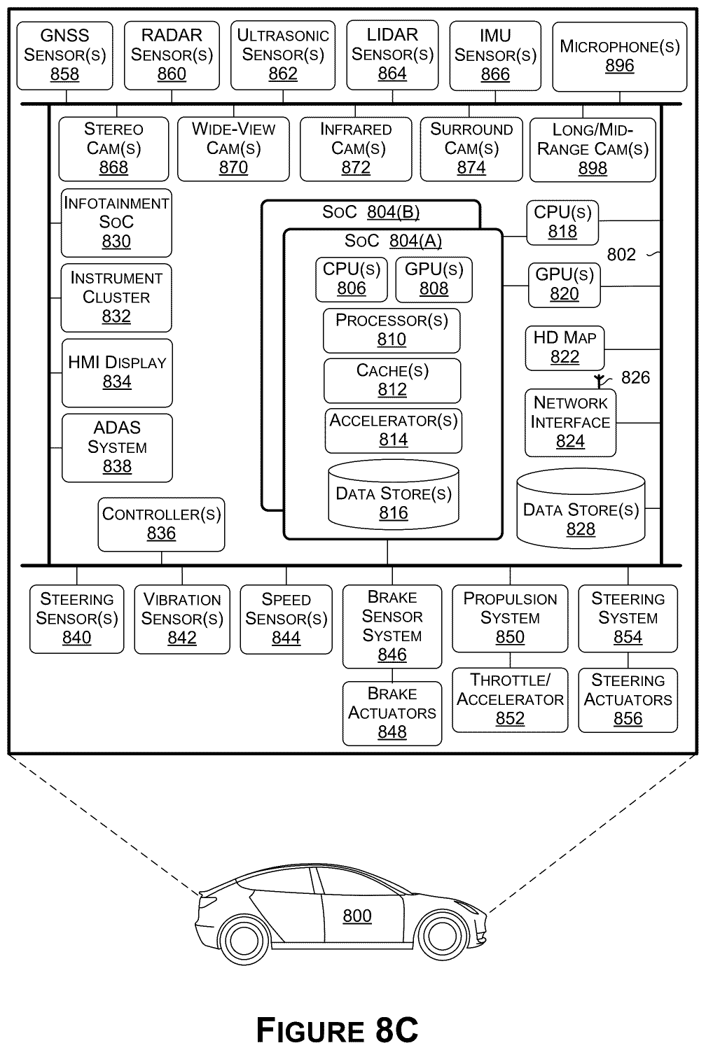

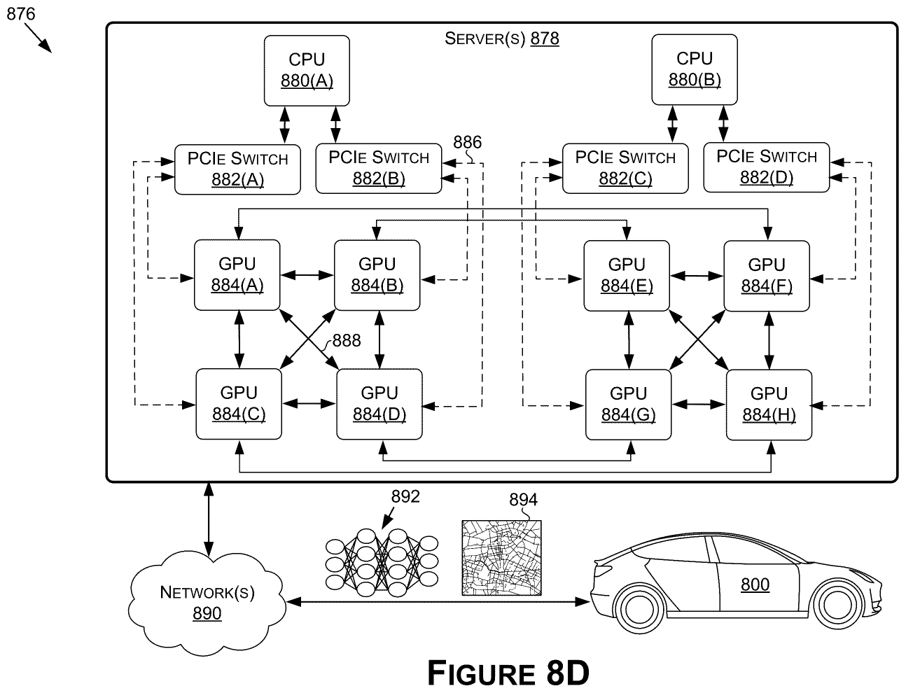

Although the present disclosure may be described with respect to an example autonomous or semi-autonomous vehicle or machine 800 (alternatively referred to herein as “vehicle 800” or “ego-machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to sensor stream selection, iterative input refinement, and/or tokenized data streaming in support of autonomous or semi-autonomous vehicle tasks such as driver monitoring, occupant monitoring, and/or environmental text perception, this is not intended to be limiting, and the systems and methods described herein may be used to support augmented reality, virtual reality, mixed reality, robotics, security and surveillance, autonomous or semi-autonomous machine applications, and/or any other technology spaces where sensor stream selection, iterative input refinement, and/or tokenized data streaming may be used.

In some embodiments, multiple sensors of an ego-machine such as a vehicle may be used to generate corresponding streams of sensor data, and a multi-modal language model may be used to select a stream to evaluate for a given detection task. Taking image data generated using multiple exterior cameras as an example, a VLM may be prompted to evaluate one or more frames of image data from each camera (e.g., resized to a designated resolution supported by the VLM)—or an identified region of interest (ROI) within each frame—and identify a relevant camera for a designated task (e.g., “Can one of the cameras see a road sign?”). The VLM may be prompted at a designated frame rate, and once the VLM identifies a camera or corresponding video stream, the VLM may be prompted to evaluate a (e.g., subsequent, higher resolution) frame of image data from the identified camera (e.g., and perform the designated detection task, identify an ROI within the higher resolution frame of image data, etc.). This sequential prompting provides the VLM with better contextual understanding and improves its accuracy. Taking an example implementation in which a visual encoder of a VLM supports an input pixel resolution of 512×512, frames of image data from different camera feeds (e.g., monitoring an interior or exterior space such as a warehouse environment) may be compressed to some lower resolution like 256×256 and (e.g., periodically) processed by a VLM to identify a relevant feed, and once the VLM identifies one of the feeds, a frame of image data from that feed may be compressed to the full input 512×512 resolution of the VLM and used for the designated detection task. As such, sensor selection may be performed at a relatively lower resolution to reduce redundant computations, reduce computational demands, and speed up processing time, prior to increasing the input resolution for the designated detection task. Embodiments such as these effectively identify the most relevant sensor or sensor data for a designated task before processing the stream at a higher (e.g., the highest available) resolution, thereby optimizing resource utilization. Embodiments involving cameras, images, and a VLM with a vision encoder are meant simply as example, and other types of sensors, sensor data, and corresponding modality encoders and multi-modal language models may be implemented within the scope of the present disclosure.

In some embodiments, a multi-modal language model such as a VLM may be iteratively prompted to identify and/or refine an ROI for a designated detection task. For example, an initial prompt may broadly focus the VLM on identifying one or more ROIs within an image. Taking an example detection task such as environmental text comprehension (e.g., understanding road signs), a VLM may be prompted with input text such as “Where would text be in this image?” to localize one or more areas in the image that may contain relevant information. Generally, a designated output format for the ROI(s) (e.g., pixel coordinates identifying vertices of bounding boxes or other bounding shapes) may be enforced in any suitable manner (e.g., using prompt engineering, post-processing, training, multiple inferences, etc.). After identifying an initial ROI, the VLM may be prompted to refine the ROI, for example, by prompting the VLM to evaluate the initial ROI and identify an ROI with more specific content than the initial prompt achieved. Continuing with the road sign comprehension example, an initial prompt may query for an ROI with text, and a subsequent prompt may query for an ROI (within the cropped initial ROI) with a road sign, and a subsequent prompt may query for an ROI (within a cropped ROI) with a particular type of road sign (e.g., an exit sign, a sign that designates restricted or toll lanes, a parking sign).

Additionally or alternatively to iteratively refining within an individual frame, some embodiments may iteratively refine an ROI over multiple frames generated over time. For example, a VLM may be prompted to evaluate and/or quantify its confidence in identifying designated content within an identified ROI in a particular frame. In some embodiments, the VLM may generate a measure of confidence that the identified ROI contains the designated content (e.g., text, road sign text), and a designated threshold may be applied. If the VLM's confidence does not meet the designated threshold, the VLM may be prompted to evaluate a subsequent frame of image data for an initial ROI, repeating the process (e.g., as the scene changes, as an ego-machine navigates an environment, etc.) until the VLM's confidence meets the designated threshold. Once the VLM's confidence meets the designated threshold, the VLM may be prompted to perform the detection task on the identified ROI. In contrast to techniques that rely on single-pass analysis of images or video streams, which can miss important details, an iterative approach may be used to gradually refine a search for relevant information performed by the VLM, effectively priming or conditioning the VLM with a chain of thought over multiple passes, improving its accuracy and localization.

Multi-modal language models typically include a modality encoder that encodes a particular type of input data (e.g., a vision encoder for a VLM encodes image data), a corresponding projector that projects the encoded input data into corresponding tokens in the same embedding space as the input text, and an LLM that processes a sequence of text and projected tokens. Continuing with a VLM as an example, the components of the VLM may be hosted by an inference server that accepts a multi-modal input prompt via an application programming interface (API) call such as a Hypertext Transfer Protocol (HTTP) (e.g., POST) request to the inference server's API endpoint, and the interface server may coordinate the data flow through the components of the VLM. The inference request typically includes the data that needs to be processed. Taking an in-vehicle application that uses a multi-modal input prompt comprising text and image data as an example, a client application that generates and issues a multi-modal input prompt may run on an in-vehicle SoC, the inference server and VLM may be offloaded to a different device to avoid consuming the SoC's resources, and prompts may be issued from the SoC to the VLM by streaming high-resolution image or video data (e.g., a compressed image file such as a JPEG file, compressed video file such as an MP4 file) from the SoC to the inference server. As such, the high-resolution image or video data may be decompressed into raw pixel data and processed by the VLM on the server.

In some embodiments, to reduce the bandwidth used to support one or more inferences, the multi-modal language model may be split up and hosted by multiple devices. For example, the modality (e.g., vision, audio) encoder and/or projector of the multi-modal language model (e.g., VLM) may be hosted on one device (e.g., an in-vehicle SoC) that encodes raw sensor data into corresponding tokens and streams the tokens to a second device (e.g., an external graphic processing unit (GPU) or artificial intelligence (AI) accelerator) that hosts an inference server and the LLM of the multi-modal language model. Taking a VLM as an example, a vision encoder may be used to transform image data into a high-dimensional latent space, a corresponding projector may tokenize the encoded image data into a rich latent representation, and the tokens may be streamed over a connection (e.g., from one device to another) and applied directly to an LLM on the receiving end of the connection to infer meaningful representations, for example, without decompression. Encoding sensor data into tokens and streaming the tokens instead of the (e.g., compressed) sensor data uses less bandwidth and improves data synchronization (e.g., reduces misalignments in timing between multiple sensor data feeds being processed substantially simultaneously). Furthermore, streaming tokens instead of compressing, streaming, and decompressing sensor data eliminates computational steps, reduces computational demands, and speeds up processing time. The benefits are compounded in applications involving multiple sensor streams and/or when operating in environments with limited computational power (e.g., in-vehicle computing). Moreover, streaming tokens instead of sensor data improves security since the latent representation that gets streamed is typically implementation-specific and therefore should be robust to man-in-the-middle attacks. In other words, the tokenized representation of sensor data cannot be used to reverse the encoding and extract the original sensor data, improving the security of the transmission line.

As such, the present techniques may be used to increase the accuracy and performance of driver monitoring, occupant monitoring, environmental text perception, and/or other tasks that use VLMs or other multi-modal language models.

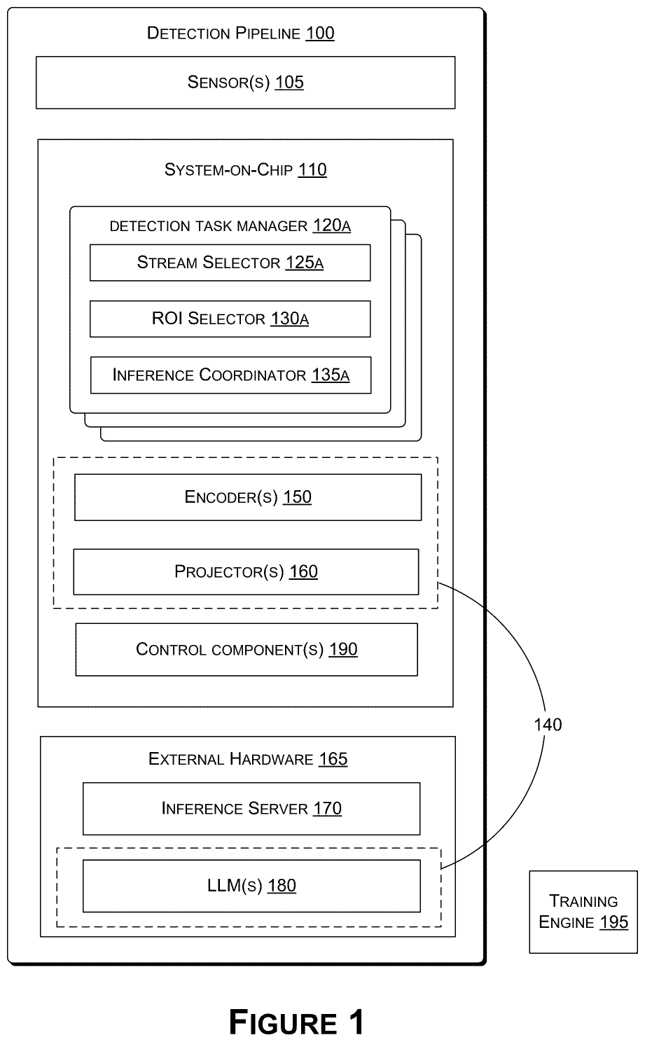

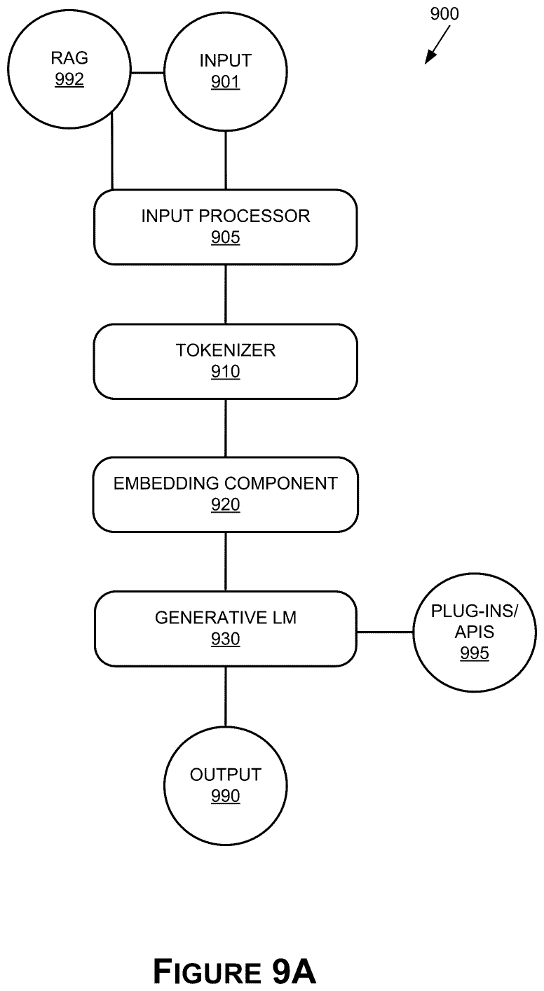

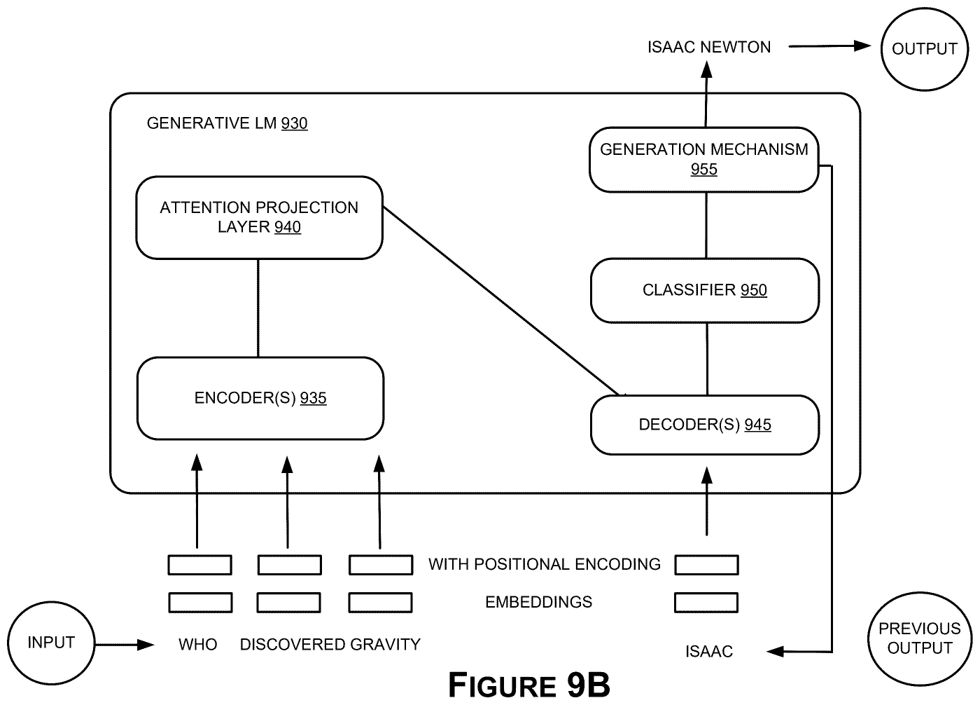

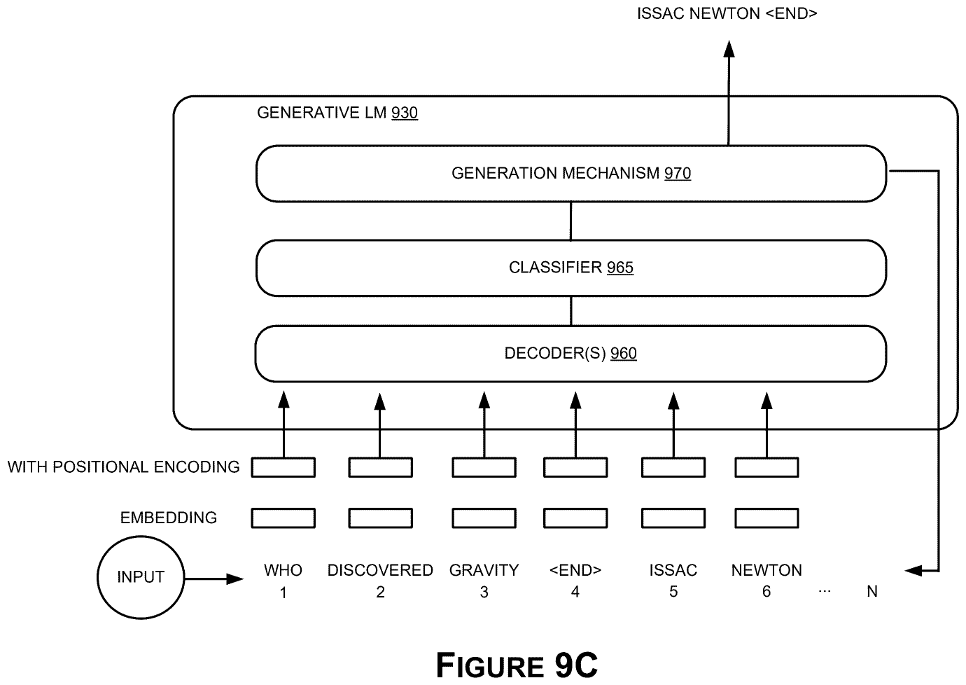

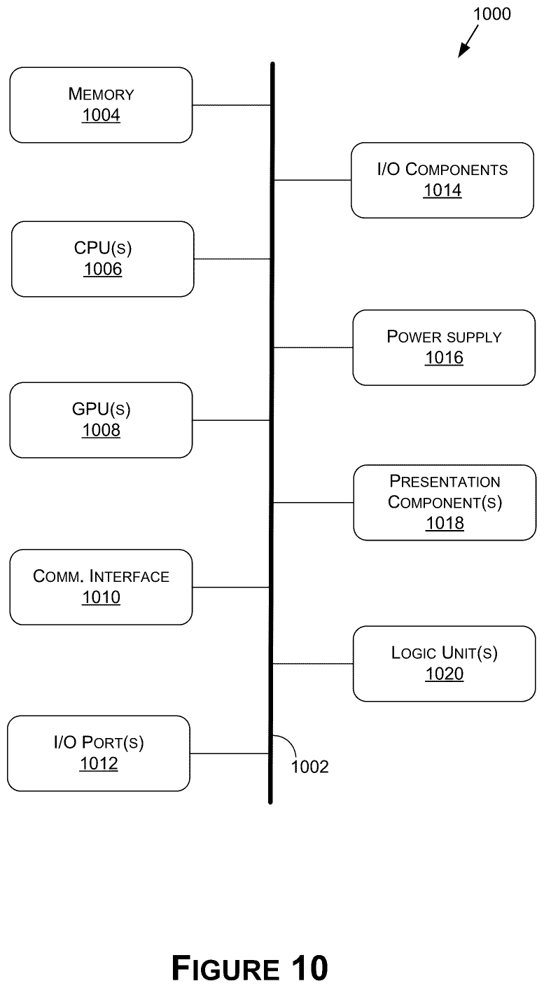

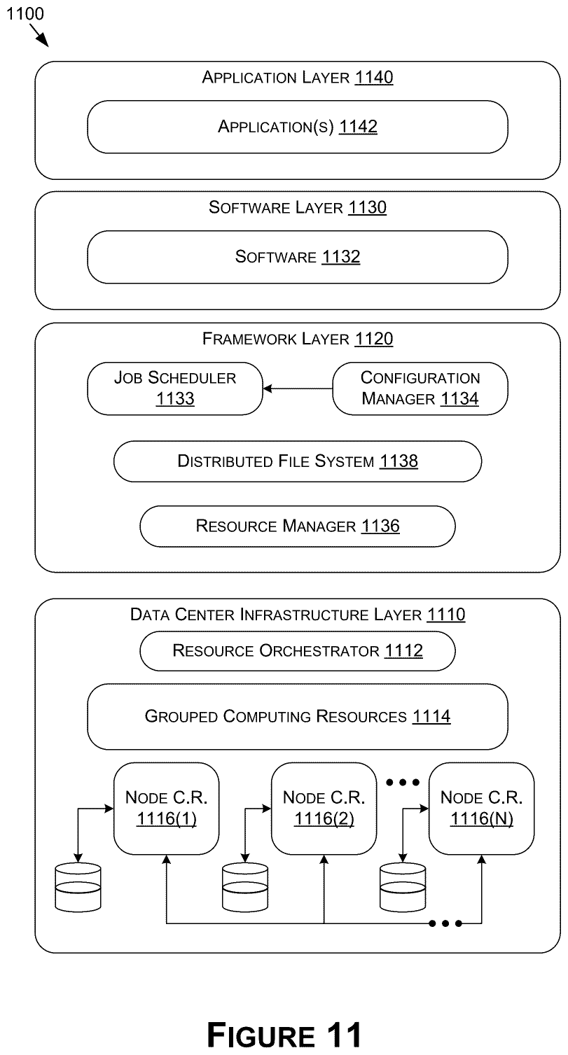

With reference to FIG. 1, FIG. 1 is an example detection pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of the example autonomous vehicle 800 of FIGS. 8A-8D, the example generative language model system 900 (e.g., as described in FIGS. 9A-9C), the example computing device 1000 of FIG. 10, and/or the example data center 1100 of FIG. 11.

As a high-level overview, some or all of the detection pipeline 100 may be incorporated into an ego-machine, such as the autonomous vehicle 800 of FIGS. 8A-8D. In the embodiment illustrated in FIG. 1, the detection pipeline 100 includes sensor(s) 105, detection task manager(s) 120a-n, one or more multi-modal language models 140 (comprising one or more encoder(s) 150, projector(s) 160, and LLM(s) 180), and control component(s) 190. Generally, any given implementation may include any number of detection task manager(s) 120a-n for corresponding (e.g., image, video, audio, etc.) detection tasks and/or any number of multi-modal language models 140 (e.g., VLM(s), video language models, audio language models, etc.), whether hosted and executing locally (e.g., on hardware of the autonomous vehicle 800) and/or some remote location (e.g., in the data center 1100 of FIG. 11). Although some embodiments may be implemented with a single multi-modal language model serving multiple detection tasks, this is meant simply as an example configuration.

In some embodiments, a system-on-chip (SoC) 110 hosts and executes one or more components of the detection pipeline 100. For example, some or all of the detection pipeline 100 may be incorporated into an ego-machine such as the autonomous vehicle 800 of FIGS. 8A-8D, and the SoC 110 (which may correspond to the SoC(s) 804 of FIG. 8C) may be an automotive SoC (e.g., the NVIDIA DRIVE Orin™ SoC) and may serve as a central computer for in-vehicle computing. An SoC like Orin is a specific type of chip that integrates various components of a computer onto a single chip, such as a central processing unit (CPU), graphics processing unit (GPU), image signal processor (ISP), deep learning or AI accelerator (DLA), memory, input/output interfaces, and/or other specialized processing units. An automotive or in-vehicle SoC may be responsible for real-time processing of sensor data generated by the sensor(s) 105, perception tasks (e.g., object detection, lane tracking), navigational decision-making (e.g., path planning, obstacle avoidance), and/or managing communication with other components and external networks. Other types of SoCs which may be used in robots or ego-machines include AI-optimized SoCs (e.g., NVIDIA Jetson Series), robotics SoCs (e.g., for robotics applications such as drones, service robots, or industrial robots), industrial SoCs (e.g., for industrial robots or automation systems for factory automation, robotics, or control systems), drone and unmanned aerial vehicle (UAV) SoCs (e.g., for handling flight control, navigation, and/or real-time video processing), and/or others.

In some embodiments, the SoC 110 is connected to external hardware 165 that hosts and/or executes one or more components of the detection pipeline 100. For example, the external hardware 165 may comprise one or more external GPUs, high-performance storage, AI accelerators (e.g., tensor processing units (TPUs), field-programmable gate arrays (FPGAs), etc.), a dedicated server hosting one or more of the foregoing, and/or other types of hardware that communicate with the SoC 110 using one or more communication channels. For example, the external hardware 165 may be connected to the SoC 110 via—and communicate over—a physical interface (e.g., peripheral component interconnect express (PCIe), M.2, USB, or Thunderbolt). In some embodiments, to reduce the compute bandwidth and other resources used by the SoC to transfer data over a physical interface, the external hardware 165 may be connected to the SoC 110 via—and communicate over—one or more networks (e.g., a network internal to the ego-machine such as an in-vehicle network, one or more external networks, etc.). For example, the external hardware 165 may include a dedicated server (e.g., located in the ego-machine, in a data center, etc.) comprising one or more GPUs, AI accelerators, and/or other components. In the embodiment illustrated in FIG. 1, the external hardware 165 hosts and/or executes an inference server 170 and one or more LLM(s) 180. However, the embodiment illustrated in FIG. 1 is meant simply as an example configuration, and other variations are contemplated within the scope of the present disclosure (e.g., including embodiments in which all components of one or more of the multi-modal language model(s) 140 execute on the same hardware device, embodiments in which different models execute on different hardware devices, etc.).

Continuing with a high-level overview, and taking the detection task manager 120a as an example, the sensor(s) 105 may be used to generate sensor data representing an interior or exterior space, the detection task manager 120a may prompt the multi-modal language model(s) 140 (e.g., the encoder(s) 150, the projector(s) 160, and the LLM(s) 180) to perform a corresponding detection task by evaluating a representation of corresponding sensor data, and the multi-modal language model(s) 140 (e.g., the LLM(s) 180) may return a response indicating the result(s) of the requested detection task. As such, the detection task manager 120a may provide a corresponding control component(s) 190 with a representation of the result(s), and the control component(s) 190 may take some responsive action. Generally, the sensor(s) 105, the control component(s) 190, and/or the responsive action may depend on the detection task and/or the implementation.

The sensor(s) 105 may include any number and/or any type of sensor, such as, without limitation, one or more cameras, LiDAR sensors, RADAR sensors, and/or other sensor types such as those described below with respect to the autonomous vehicle 800 of FIGS. 8A-8D. Taking a perception task such as a driver monitoring systems (DMS) or occupant monitoring systems (OMS) task as an example, the sensor(s) 105 may be positioned to perceive one or more humans or other subjects (e.g., objects left behind) in an interior or exterior space or other environment in which one or more humans or other subjects may be present (e.g., seating, footwells, etc.), and may be used to generate frames of sensor data (e.g., images) at any suitable frame rate. More generally, the sensor(s) 105 may include one or more sensors of an ego-machine (e.g., an OMS or DMS camera such as the OMS sensor(s) 801 of the vehicle 800, one or more exterior cameras such as the stereo camera(s) 868, wide-view camera(s) 870 (e.g., fisheye cameras), infrared camera(s) 872, surround camera(s) 874, and/or long-range and/or mid-range camera(s) 898 of the vehicle 800, etc.), and the sensor(s) 105 may be used to generate frames of sensor data that represent an environment being monitored (e.g., an environment outside an ego-machine, an interior space, an operator or occupant of an ego-machine, some other monitored subject or space, etc.).

Taking a monitoring system such as a vehicle OMS as an example, one or more optical sensors may be positioned to perceive a scene within a cabin, cockpit, or other interior or exterior space. An OMS may comprise a DMS, a system that monitors non-driver occupants, or a system that monitors driver (operator) occupant(s) and/or non-driver occupant(s). OMSs often rely on perception from multiple optical sensors (e.g., RGB sensors, infrared IR sensors, depth sensors, cameras, etc.) positioned at various locations throughout a vehicle interior. Vehicle manufacturers tend to vary the number of OMS cameras from model to model and depending on the trim level. Base models usually have one camera facing the driver (e.g., positioned within a steering column, vehicle pillar, or infotainment console). Higher trim levels may include any number of additional cameras (e.g., one in the steering column facing the driver, one in the rear review mirror facing the driver or the cabin, one in a vehicle pillar facing a particular row of seating, one above a row of headrests facing forward for child detection, etc.). Generally, occupant and/or driver monitoring systems may include any number of cameras (e.g., 4 DMS cameras and 16 OMS cameras) positioned throughout a vehicle interior. These are just a few examples of possible sensor layouts, and other sensor layouts within any suitable interior scene (e.g., supermarket aisle, hospital operating room, retail store, office space, manufacturing facility, warehouse facility, etc.) or exterior scene (e.g., city street, construction site, agricultural field, public transportation hub, urban environment, etc.) may be implemented within the scope of the present disclosure.

Any or all of the sensor(s) 105 may be used to generate a frame of sensor data (e.g., an image generated using each of one or more OMS and/or exterior cameras) for each time slice (e.g., at any suitable frame rate, which may depend on the sensor, detection task, implementation, and/or other factors), and the detection task manager 120a may use the frame of sensor data from corresponding sensor(s) 105 to prompt and/or coordinate inferences performed by the multi-modal language model(s) 140 at any suitable frame rate (whether or not at the same rate the sensor data was generated). In some embodiments, different detection tasks may operate at different frame rates.

Depending on the implementation, the detection task manager 120a may manage any suitable detection task, for example, by determining when to perform an inference, determining which sensor data to evaluate (optionally using a corresponding stream selector 125a and/or ROI selector 130A), generating a representation of a prompt that uses (e.g., structured) input(s) to instruct the multi-modal language model(s) 140 to perform a detection task evaluating the sensor data, issuing the prompt (e.g., to an inference coordinator 135a for) the multi-modal language model(s) 140, coordinating (e.g., by the inference coordinator 135a) data flow through the components of the multi-modal language model(s) 140 (e.g., in some embodiments in which at least portion of the multi-modal language model(s) 140 is hosted and/or executes on the same device as the detection task manager 120a), processing one or more responses from the multi-modal language model(s) 140, and/or providing a representation of the response(s) to corresponding control component(s) 190 or otherwise instructing the corresponding control component(s) 190 to take a corresponding action.

In some embodiments and/or scenarios, multiple sensors may be positioned and/or oriented to observe a condition being monitored. For example, different interior cameras may provide different views of occupants being monitored, and depending on where the occupants are positioned, one camera may be in positioned and oriented to generate better image data for a designated detection task than another. In another example, depending on where a child car seat is positioned and how it is oriented, one camera may be positioned and oriented to generate better image data for detecting the presence of a child in the car seat than other cameras. In an example outside a vehicle, multiple exterior cameras may observe different views of the surrounding environment, and one camera may be positioned and oriented to observe an approaching road sign than the others. In a warehouse environment or other facility being monitored, depending on what is happening at any given time, some camera feeds may be more relevant than others. There are a variety of detection tasks in which multiple sensors could potentially generate relevant sensor data, but depending on the configuration of the scene at any given time, some sensors might generate sensor data that is relevant for a designated task, while other sensors might not.

Accordingly, in some embodiments, the detection task manager 120a for a designated task may include a stream selector 125a that triggers the multi-modal language model(s) 140 (e.g., a VLM) to select which sensor data from which of a plurality of sensors to evaluate for the designated task. Taking an example embodiment in which the sensor(s) 105 comprise multiple exterior cameras that generate corresponding image data of the environment surrounding an ego-machine such as vehicle, and in which the multi-modal language model(s) 140 comprise a VLM, the stream selector 125a may prompt the VLM to evaluate one or more frames of image data from each camera (e.g., a combined representation such as a tiled image, sequentially evaluating each image separately)—or an identified ROI within each frame—and may identify whether one of the cameras is relevant for a designated task (e.g., using a prompt that includes a question such as “Can one of the cameras see [e.g., a road sign]?”).

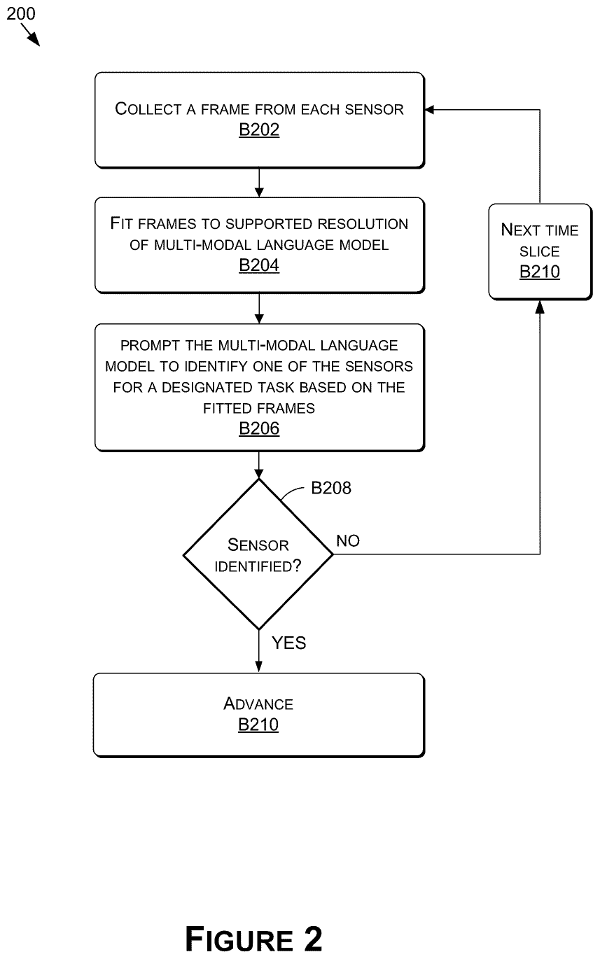

FIG. 2 is a flow diagram showing a method 200 for sensor stream selection, in accordance with some embodiments of the present disclosure. In some embodiments, the stream selector 125a of FIG. 1 may execute at least a portion of the method 200. For example, at block B202, the stream selector 125a may collect or otherwise identify one or more frames of sensor data from each potentially relevant sensor (e.g., forward-facing external cameras for environmental text perception, one or more OMS cameras for child presence detection, etc.). The applicable sensors typically depend on the designated task, examples of which are described in more detail below. The method 200 may operate at any suitable frame rate, whether or not the same rate the corresponding sensor data is generated. For example, if the method 200 operates slower than the sensor data is generated, the stream selector 125a may select and retrieve a most recently generated frame of sensor data from each applicable sensor.

At block B204, the stream selector 125a may fit (e.g., compress and/or crop) (e.g., each of) the frame(s) to a supported input resolution of (e.g., the encoder(s) 150 of) the multi-modal language model(s) 140. Taking an example implementation in which a visual encoder of a VLM supports an input pixel resolution of 512×512, the stream selector 125a may fix the aspect ratio of each image and resize the image to fit the input resolution (e.g., cutting off the sides of the image). In some embodiments, the stream selector 125a may compress any given frame to a lower resolution than the encoder(s) 150 support (e.g., to conserve resources and speed up the inference). In some embodiments, the stream selector 125a may trigger the ROI selector 130a to identify an ROI within one or more of the frames (as described in more detail below), and the stream selector 125a may fit the ROI to the input resolution of the multi-modal language model(s) 140 (if necessary).

Additionally or alternatively, the stream selector 125a may compress any given frame to a supported resolution selected based on a detected environment. For example, the stream selector 125a may detect an applicable environmental domain (e.g., urban vs. highway) using a mapping API. For example, roads and corresponding environmental domains may be represented in a database using corresponding coordinates, boundaries, regions, or other features. The stream selector 125a may determine the ego-machine's location using any known technique (e.g., a Global Navigation Satellite System (GNSS) or Global Positioning System (GPS)) and may provide the location via a mapping API to a location-based service that cross-references a database to determine and return the applicable environmental domain. Detection tasks performed on sensor data representing certain domains (e.g., urban environments) may benefit from using higher resolution sensor data. As such, one or more detected environmental domains (e.g., urban environments) may be mapped to a relatively higher input resolution (e.g., 512×512), and one or more other detected environmental domains (e.g., highway environments) may be mapped to a relatively lower input resolution (e.g., 256×256). As such, at block B204, the stream selector 125a may fit (e.g., compress and/or crop) (e.g., each of) the frame(s) to a selected input resolution corresponding to a detected environmental domain.

At block B206, the stream selector 125a may prompt the multi-modal language model(s) 140 (e.g., via the inference coordinator 135a and the inference server 170) to identify one of the sensors for a designated task based on the fitted frames of sensor data. For example, the stream selector 125a may generate and issue (e.g., to the inference coordinator 135a) a multi-modal prompt comprising a representation of the fitted frames of sensor data (e.g., resized, cropped, and/or tiled images) and a text prompt that instructs, primes, or otherwise triggers the multi-modal language model(s) 140 to determine whether one of the sensors, sensor feeds, and/or frames of sensor data represents a scene or scene content that is relevant to a designated task. In some embodiments in which the multi-modal language model(s) 140 is hosted on different hardware devices (such as the embodiment illustrated in FIG. 1), the stream selector 125a may trigger the inference coordinator 135a to coordinate the inference. For example, the inference coordinator 135a may apply the representation of the fitted frames of sensor data to the encoder(s) 150 to generate an encoded representation of the fitted frames of sensor data from the different sensors, apply the encoded representation of the fitted frames to the projector(s) 160 to tokenize the encoded representation of the fitted frames of sensor data, combine (e.g., concatenate, interleave) the resulting tokens with the tokens of the text prompt to generate a sequence of tokens representing a tokenized multi-modal prompt, and issue the sequence of tokens as a prompt for the LLM(s) 180 via the inference server 170.

Generally, the modality of one or more portion(s) of the multi-modal prompt (and the corresponding type of encoder and projector) may depend on the type of sensor data being evaluated and/or the implementation. For example, image data (e.g., images generated using one or more cameras) may be used as visual input into a VLM comprising a visual encoder and a corresponding projector that projects from the embedding space of the visual encoder into the same space as the text tokens of the text prompt. In some embodiments, multiple frames of image data from each sensor may be cached over a sliding temporal window (or a corresponding vision encoder may be used to generate and store visual embeddings for the frames), any known technique may be used to sample the frames (or visual embeddings) and generate a representation of the sampled frames, and a prompt comprising a text prompt and the representation of the sampled frames may be applied to respective textual and visual input channels of a video LLM. In some embodiments, (e.g., sampled) audio data may be used as audio input into an audio language model comprising an audio encoder and a corresponding projector that projects from the embedding space of the audio encoder into the same space as the text tokens of the text prompt. In some embodiments, other types of sensor data such as RADAR data, LiDAR data, or ultrasonic data may be encoded and tokenized using a corresponding encoder-projector pair of a multi-modal language model. Additionally or alternatively, the sensor data may be used to generate a projection image by projecting the sensor data into a 2D view, and the projection image may be evaluated using a VLM. These are just a few examples, and other variations may be implemented within the scope of the present disclosure.

Furthermore, the text portion of the multi-modal prompt may depend on the applicable task and/or the implementation. Continuing with the example in which the stream selector 125a instructs, primes, or otherwise triggers the multi-modal language model(s) 140 to determine whether one of the sensors, sensor feeds, and/or frames of sensor data represents a scene or scene content that is relevant to a designated task, the stream selector 125a may use any known prompt engineering technique (e.g., using system prompts, role-based prompts, instruction prompts, question prompts, multi-turn prompts, etc.) to provide (e.g., via the inference coordinator 135a and/or the inference server 170) designated questions and/or instructions to (e.g., the LLM(s) 180 of) the multi-modal language model(s) 140 corresponding to the applicable detection task. By way of nonlimiting example, a text prompt may comprise a question such as “Which [camera/sensor] can see [the condition being monitoring for]?” or “Can one of the [cameras/sensors] see [the condition being monitoring for]?” Taking environmental text comprehension (e.g., understanding road signs) as an example, a possible text prompt may include a question such as “Which [camera/sensor] can see a road sign?” Taking child presence detection as an example, a possible text prompt may include a question such as “Which [camera/sensor] can see a child?” Taking license plate detection as an example, a possible text prompt may include a question such as “Can any of the [cameras/sensors] see a license plate?” Taking obstacle detection and avoidance as an example, a possible text prompt may include a question such as “Can any of the [cameras/sensors] see a car, road debris, or some other obstacle?” Those of ordinary skill in the art will understand how to adapt a text prompt to the designated detection task, examples of which are provided in more detail below. Whether the choice is expressed as a selection of a particular sensor, a sensor feed generated using the sensor, sensor data generated using the sensor, or otherwise, the response may effectively indicate or otherwise be representative of a selection of both the sensor and its corresponding sensor data (or sensor feed). Generally, a designated output format for sensor selection (e.g., a tag or other identifier representing the selected sensor) may be enforced in any suitable manner (e.g., using prompt engineering, post-processing, training, multiple inferences, etc.).

In some embodiments, the text portion of the multi-modal prompt corresponds to a user command or query, and may be generated using an LLM (e.g., of the LLM(s) 180 of FIG. 1). Taking an example in-cabin embodiment, an occupant may ask a digital assistant a question such as “Is my [wallet or laptop] in the car?” via an input (e.g., audio, touch) interface of the vehicle, and the digital assistant may convert the request to a textual representation and provide the request (or a portion thereof) to the detection task manager 120a to trigger the detection task manager 120a to look for the requested object (or check for some other requested condition). In some embodiments, at block B206, the stream selector 125a of the detection task manager 120a may parse the textual representation of the request to identify the requested condition (e.g., the presence of a specified object) and insert the requested condition into one or more fields of a template text prompt that instructs, primes, or otherwise triggers the multi-modal language model(s) 140 to check for a relevant sensor, sensor feed, and/or frame of sensor data (e.g., “Can one of the [cameras/sensors] see [the specified/parsed/extracted condition]?” In some embodiments, at block B206, the stream selector 125a may prompt the LLM(s) 180 to convert the user command or query into an appropriate text prompt for sensor selection (e.g., using a text prompt such as “Convert the following user input into a text prompt that instructs a VLM to check whether one of the images provided to the VLM shows what the user is asking for: [user input]”). As such, the stream selector 125a may parse the response, extract the generated text prompt, and use it as part of a multi-modal prompt for sensor selection at block B206. These are meant simply as examples, and variations may be implemented within the scope of the present disclosure.

Continuing with the method 200, at block B208, the stream selector 125a may receive one or more responses from (e.g., the LLM(s) 180 of) the multi-modal language model(s) 140 and interpret the one or more responses. For example, the multi-modal language model(s) 140 may provide a response indicating that none of the sensors is relevant to the designated task, in which case, the stream selector 125a may parse the response, determine the response indicates that none of the sensors is relevant (e.g., none of the sensor data represents a relevant scene or scene content), and, at block B210, wait for the next time slice and return to block B202. As such, the stream selector 125a may iterate the method 200 in a loop at a designated frame rate until the multi-modal language model(s) 140 provide a response identifying a selected sensor that is relevant to the designated task, upon which, the stream selector 125a may advance to block B210. Generally, the next step of the process may depend on the implementation. In some embodiments, at block B210, the stream selector 125a may trigger the detection task manager 120a to evaluate the applicable detection task (e.g., whether one or more target conditions of the applicable detection task are present, performing scene or text perception, etc.) using a (e.g., current or subsequent, higher resolution) frame of sensor data from the identified sensor. In some embodiments, at block B210, the stream selector 125a may trigger the ROI selector 130a to identify a relevant ROI within a (e.g., current or subsequent, higher resolution) frame of sensor data from the identified sensor.

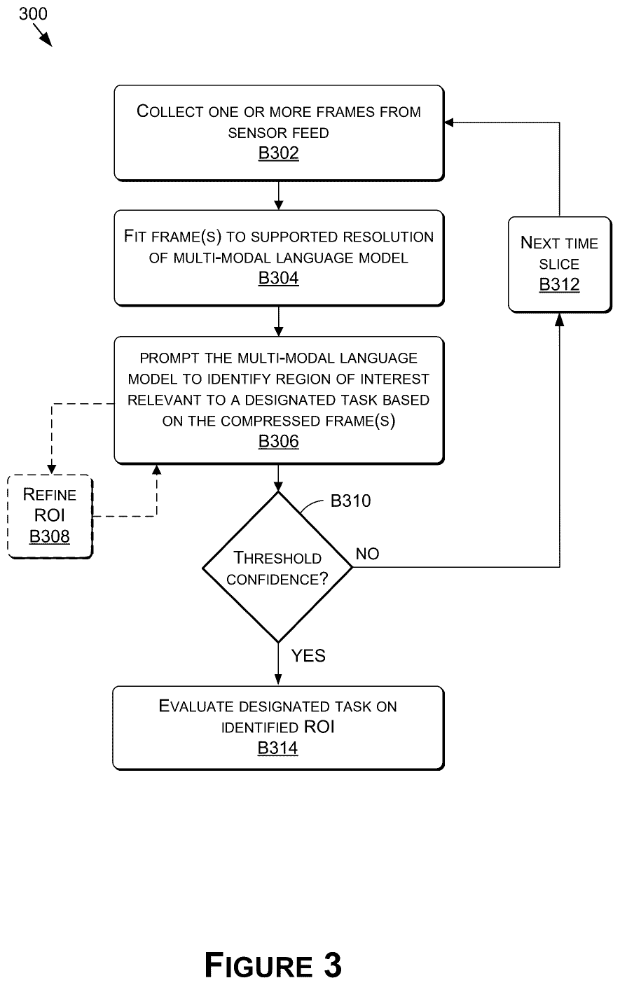

More specifically and turning now to FIG. 3, FIG. 3 is a flow diagram showing a method 300 for iterative input refinement, in accordance with some embodiments of the present disclosure. In some embodiments, the ROI selector 130a of FIG. 1 may execute at least a portion of the method 300. For example, at block B302, the ROI selector 130a may collect or otherwise identify one or more frames of sensor data from a sensor feed (e.g., of a selected sensor, of a designated sensor) for a designated detection task. For example, the ROI selector 130a may use a single frame for image detection tasks, or may cache and sample frames for video detection tasks. Generally, the method 300 may operate any suitable frame rate, whether or not the same rate the corresponding sensor data is generated. In some embodiments in which the method 300 is triggered by the stream selector 125a (e.g., at block B210 of the method 200), the ROI selector 130a may operate at a faster frame rate than the stream selector 125a operated the method 200.

At block B304, the ROI selector 130a may fit (e.g., compress and/or crop) (e.g., each of) the frame(s) to a supported input resolution of (e.g., the encoder(s) 150 of) the multi-modal language model(s) 140. Taking an example implementation in which a visual encoder of a VLM supports an input pixel resolution of 512×512, the ROI selector 130a may fix the aspect ratio an image and resize it to fit the (e.g., maximum) input resolution (e.g., cutting off the sides of the image). In some embodiments in which the method 300 is triggered by the stream selector 125a (e.g., at block B210 of the method 200), the ROI selector 130a may fit the frame(s) of sensor data to a higher resolution supported by the multi-modal language model(s) 140 than the stream selector 125a used at block B204 of the method 200. In some embodiments, the ROI selector 130a may fit (e.g., compress and/or crop) (e.g., each of) the frame(s) to a selected input resolution corresponding to a detected environmental domain (e.g., as described in more detail with respect to block B204 of the method 200).

At block B306, the ROI selector 130a may prompt the multi-modal language model(s) 140 (e.g., via the inference coordinator 135a and the inference server 170) to identify a region of interest for a designated task based on the fitted frame(s) of sensor data. For example, the ROI selector 130a may generate and issue (e.g., to the inference coordinator 135a) a multi-modal prompt comprising a representation of the fitted frame(s) of sensor data (e.g., resized, cropped, and/or sampled frames) and a text prompt that instructs, primes, or otherwise triggers the multi-modal language model(s) 140 to determine whether one or more regions represented by the frame(s) of sensor data represent a scene or scene content that is relevant to a designated task and/or identify a representation (e.g., coordinates, boundaries, or other features) of such ROI(s). In some embodiments in which the multi-modal language model(s) 140 is hosted on different hardware devices (such as the embodiment illustrated in FIG. 1), the ROI selector 130a may trigger the inference coordinator 135a to coordinate the inference. For example, the inference coordinator 135a may apply the representation of the fitted frame(s) of sensor data to the encoder(s) 150 to generate an encoded representation of the fitted frame(s) of sensor data, apply the encoded representation of the fitted frame(s) to the projector(s) 160 to tokenize the encoded representation of the fitted frame(s) of sensor data, combine (e.g., concatenate, interleave) the resulting tokens with the tokens of the text prompt to generate a sequence of tokens representing a tokenized multi-modal prompt, and issue the sequence of tokens as a prompt for the LLM(s) 180 via the inference server 170.

As with other possible tasks described herein, the modality of one or more portion(s) of the multi-modal prompt (and the corresponding type of encoder and projector) may depend on the type of sensor data being evaluated and/or the implementation, and the text portion of the multi-modal prompt may depend on the applicable task and/or the implementation. Continuing with the example in which the ROI selector 130a instructs, primes, or otherwise triggers the multi-modal language model(s) 140 to determine whether one or more regions represented by the frame(s) of sensor data represent a scene or scene content that is relevant to a designated task, the ROI selector 130a may use any known prompt engineering technique (e.g., using system prompts, role-based prompts, instruction prompts, question prompts, multi-turn prompts, etc.) to provide (e.g., via the inference coordinator 135a and/or the inference server 170) designated questions and/or instructions to (e.g., the LLM(s) 180 of) the multi-modal language model(s) 140 corresponding to the applicable detection task. By way of nonlimiting example, a text prompt may comprise a question such as “Where would [the condition being monitoring for] be in this [image/frame]?” or “Is there a region in this [image/frame] that depicts [the condition being monitoring for]?” Taking environmental text comprehension (e.g., understanding road signs) as an example, a possible text prompt may include a question such as “Where would text be in this image?” Taking child presence detection as an example, a possible text prompt may include a question such as “Is there a region in this image that depicts a child?” Those of ordinary skill in the art will understand how to adapt a text prompt to the designated detection task, examples of which are provided in more detail below. Generally, a designated output format for the ROI(s) (e.g., pixel coordinates identifying vertices of bounding boxes or other bounding shapes) may be enforced in any suitable manner (e.g., using prompt engineering, post-processing, training, multiple inferences, etc.).

In some embodiments, the text portion of the multi-modal prompt may depend on a user command or query, and may be generated using an LLM (e.g., of the LLM(s) 180 of FIG. 1). Taking an example in-cabin embodiment, an occupant may ask a digital assistant a question such as “Is my [wallet or laptop] in the car?” via an input (e.g., audio, touch) interface. In some embodiments, the digital assistant may trigger the stream selector 125a to identify whether one of a plurality of sensor feeds is relevant to the user command or query, in which case, the stream selector 125a may trigger the ROI selector 130a to look for a relevant ROI in a frame(s) of sensor data from the selected sensor. In some embodiments, the digital assistant may trigger the ROI selector 130a to look for the requested object (or check for some other requested condition) in a frame of sensor data from one or more designated sensors selected some other way (e.g., a frame(s) from a pre-determined sensor, from each a plurality of supported sensors, etc.). In any event, at block B306, the ROI selector 130a (or some other component) of the detection task manager 120a may parse the textual representation of the request to identify the requested condition (e.g., the presence of a specified object) and insert the requested condition into one or more fields of a template text prompt that instructs, primes, or otherwise triggers the multi-modal language model(s) 140 to determine whether one or more regions represented by the frame(s) of sensor data represent a scene or scene content that is relevant to the task identified or represented by the command or query (e.g., “Is there a region in this [image/frame] that depicts [the specified/parsed/extracted condition]?” In some embodiments, at block B306, the ROI selector 130a may prompt the LLM(s) 180 to convert the user command or query into an appropriate text prompt for ROI selection (e.g., using a text prompt such as “Convert the following user input into a text prompt that instructs a VLM to identify a region in the image that shows what the user is asking for: [user input]”). As such, the ROI selector 130a may parse the response, extract the generated text prompt, and use it as part of a multi-modal prompt for ROI selection at block B306. These are meant simply as examples, and variations may be implemented within the scope of the present disclosure.

As such, the ROI selector 130a may prompt for—and receive—one or more responses from (e.g., the LLM(s) 180 of) the multi-modal language model(s) 140, and the ROI selector 130a may interpret the one or more responses accordingly. For example, the multi-modal language model(s) 140 may provide a response indicating there are no ROIs relevant to the designated task, in which case, the ROI selector 130a may parse the response, determine the response indicates there are no ROIs, and (not illustrated) wait for the next time slice and return to block B302 (or block B202 of FIG. 2), collecting or otherwise identifying one or more subsequent frames from a subsequent time slice. As such, the ROI selector 130a may iterate (e.g., in a loop at a designated frame rate) until the multi-modal language model(s) 140 provides a response identifying one or more ROIs relevant to a designated task, upon which, the ROI selector 130a may parse the response, determine that it identifies one or more ROIs, extract a representation of the identified ROI(s), and advance to block B308, B310, and/or B314 (e.g., depending on the implementation).

In some embodiments, at block B308, the ROI selector 130a may refine the identified ROI(s) using one or more subsequent prompts. For example, the prompt used by the ROI selector 130a at block B306 may represent a broader inquiry (e.g., asking the model to identify a region of interest), and at block B308, the ROI selector 130a may instruct, prime, or otherwise trigger the multi-modal language model(s) 140 using a more specific inquiry. For example, an initial prompt may broadly focus the multi-modal language model(s) 140 on identifying one or more ROIs, and once the multi-modal language model(s) 140 identify an ROI, the ROI selector 130a may prompt the multi-modal language model(s) 140 to refine the ROI, for example, by prompting the multi-modal language model(s) 140 to evaluate a (e.g., full resolution) representation of the initial ROI for a more specific condition than the initial prompt. Continuing with a road sign comprehension example, an initial prompt issued at block B306 may query for an ROI that contains text, and a subsequent prompt issued at block B308 may query for an ROI (within the initial ROI) containing a road sign. In some embodiments, the ROI selector 130a may repeat block B308, iteratively refining the ROI by querying for an ROI (e.g., a subregion of interest within a previously identified ROI) containing successively more specific condition(s). For example, the ROI selector 130a may query for an ROI that contains text, then query for a sub-ROI that contains a road sign, then query for a sub-ROI that contains specific target text relevant to the designated task (e.g., the word “exit” or “park”). As such, the ROI selector 130a may issue prompts that iteratively narrow the focus of the multi-modal language model(s) 140, incrementally or progressively narrowing or tightening the search scope or specified search parameters represented by the text portion of the prompt to iteratively refine an ROI for a designated task.

Furthermore, the ROI selector 130a may increase the input resolution used in one or more subsequent prompts at block B308. For example, once the multi-modal language model(s) 140 identifies an ROI within the representation of the fitted frame(s) of sensor data (e.g., a full frame compressed and cropped to a supported input resolution) at block B306, the ROI selector 130a may crop the identified ROI (e.g., or a dilated representation thereof), fit (e.g., compress and/or crop) the resulting (e.g., cropped ROI) to a supported input resolution of (e.g., the encoder(s) 150 of) the multi-modal language model(s) 140, and apply the resulting fitted ROI to the multi-modal language model(s) 140 as part of a subsequent prompt. As such, the multi-modal language model(s) 140 may be provided with a representation of an identified ROI with an increased resolution as part of a subsequent prompt.

Additionally or alternatively to iteratively refining within an individual frame, some embodiments may iteratively refine an ROI over multiple frames generated over time. For example, the ROI selector 130a may instruct, prime, or otherwise trigger the multi-modal language model(s) 140 to evaluate and/or quantify its confidence in identifying designated content within an identified ROI. In some embodiments, the multi-modal language model(s) 140 may be constrained (e.g., using prompt engineering, post-processing, training, multiple inferences, etc.) to identify a measure of confidence in an identified ROI (e.g., whether in the same response that identifies the ROI or in some subsequent response). Any suitable measure of confidence may be used (e.g., a percentage, a confidence within some interval such as [0,1], a binary measure, etc.). As such, at block, B310, the ROI selector 130a may parse the response from the multi-modal language model(s) 140 to extract the generated measure of confidence and apply a designated threshold to the measure of confidence. If the measure of confidence does not meet the designated threshold, the ROI selector 130a may advance to block B312 and wait for the next time slice, and return to block B302. As such, the ROI selector 130a may iterate the method 300 in a loop at a designated frame rate, prompting the multi-modal language model(s) 140 to evaluate updated sensor data (e.g., as the scene changes, as an ego-machine navigates an environment, etc.) until the multi-modal language model(s) 140 provides a response identifying an ROI with a measure of confidence that meets the designated threshold, upon which, the ROI selector 130a may advance to block B314, at which the ROI selector 130a may trigger the multi-modal language model(s) 140 to evaluate the applicable detection task (e.g., whether one or more target conditions of the applicable detection task are present, performing scene or text perception, etc.) using the identified ROI (e.g., at full resolution or fitted to the input resolution of the multi-modal language model(s) 140).

In some embodiments, once the multi-modal language model(s) 140 identify an ROI (e.g., within a frame of sensor data compressed to a supported input resolution) at block B306, the ROI selector 130a may increase the input resolution used in one or more subsequent prompts at block B314. For example, the multi-modal language model(s) 140 may be constrained (e.g., using prompt engineering, post-processing, training, multiple inferences, etc.) to identify an ROI of a designated dimensionality (e.g., the maximum supported input resolution of the multi-modal language model(s) 140), such that the identified ROI does not need to be compressed or resized before applying it to a corresponding input channel of the multi-modal language model(s) 140. In this scenario, the previous prompt may incorporate compressed data whereas a subsequent prompt at block B314 may incorporate the full resolution of the available sensor data.

Note that the implementation illustrated in FIG. 3 is meant simply as an example, and other variations may be implemented within the scope of the present disclosure. For example, in some embodiments, when the multi-modal language model(s) 140 identify an ROI at block B306, the ROI selector 130a may advance directly to block B314 and evaluate the designated task on the identified ROI. some embodiments and/or scenarios, the multi-modal language model(s) 140 may identify multiple ROIs (e.g., representing different types of detected objects), in which case, the ROI selector 130a may proceed with one or more of the identified ROIs (e.g., process each ROI separately and issue a batch request and/or corresponding prompts for the multi-modal language model(s) 140 to evaluate each ROI, select and process only the ROI identified with the highest measure of confidence, select and process all ROIs identified with a measure of confidence above some threshold, etc.).

Returning to FIG. 1, the multi-modal language model(s) 140 may use any known architecture capable of processing text and one or more other modalities (e.g., image data, video data, audio data, 3D data, etc.). For example, the multi-modal language model(s) 140 (e.g., which may correspond to the example generative language model system 900 of FIG. 9A) may include a modality encoder and projector corresponding to the applicable modality (e.g., the encoder(s) 150 and the projector(s) 160), and one or more language models (LMs) (e.g., the LLM(s) 180) such as the generative LM 930 of FIGS. 9A, 9B, or 9C. Depending on the implementation, the multi-modal language model(s) 140 may include a pre-trained or foundational LLM, such as NVIDIA's Megatron-Turing Natural Language Generation (MT-NLG) or Megatron-LM; OpenAI's GPT series; Google's T5 or Pathways Language Model (PaLM); Meta's BlenderBot or Large Language Model Meta AI (LLaMA) series, Anthropic's Claude series, or others.

Generally, the multi-modal language model(s) 140 may perform some detection tasks by evaluating a multimodal prompt comprising a text prompt that is applied to a textual input channel and some other type of associated data (e.g., an image generated using a camera, sampled audio data, sampled video data, 3D data, etc.) that is applied to a corresponding input channel (e.g., comprising the encoder(s) 150). some embodiments, the multi-modal language model(s) 140 include one or more VLM(s) that perform detection task(s) by evaluating a multimodal prompt comprising a text prompt that is applied to a textual input channel and a visual prompt that is applied to a corresponding visual input channel. Some detection tasks such as driver drowsiness or distraction detection may benefit from temporal context. As such, in some embodiments, the multi-modal language model(s) 140 include one or more vision language models (e.g., Language Instructed Temporal-Localization Assistant (LITA)) capable of evaluating a text prompt and associated input video data (e.g., a representation of multiple sampled frames of image data from a video). For example, the detection task manager 120a may include a frame queue and may store frames of image data from a sliding temporal window (or may use a corresponding vision encoder to generate and store visual embeddings for the frames) in the frame queue, may use any known technique to sample the frames and generate a representation of the sampled frames (e.g., sampling frames or slow tokens over a longer temporal window to represent spatial information and/or sampling frames or fast tokens over a shorter temporal window to represent temporal information), and may apply a prompt comprising a text prompt and the representation of the sampled frames to respective textual and visual input channels of a video LLM (or otherwise identify the prompt for the video LLM). These are meant simply as examples, and other architectures may be implemented within the scope of the present disclosure.

As such, the detection task manager 120a may prompt the multi-modal language model(s) 140 (e.g., via the inference coordinator 135a and the inference server 170) to generate one or more responses that evaluate a designated task based on the scene represented in the (e.g., selected ROI of the) sensor data. For example, the detection task manager 120a may generate and issue (e.g., to the inference coordinator 135a) a multi-modal prompt comprising a representation of the (e.g., selected ROI within the) frame(s) of sensor data (e.g., resized, cropped, and/or sampled frames) and a text prompt that instructs, primes, or otherwise triggers the multi-modal language model(s) 140 to evaluate the designated task based on the frame(s) of sensor data. In some embodiments in which the multi-modal language model(s) 140 is hosted on different hardware devices (such as the embodiment illustrated in FIG. 1), the detection task manager 120a may trigger the inference coordinator 135a to coordinate the inference. For example, the inference coordinator 135a may apply a representation of the frame(s) of sensor data to the encoder(s) 150 to generate an encoded representation of the frame(s) of sensor data, apply the encoded representation of the frame(s) to the projector(s) 160 to tokenize the encoded representation of the frame(s) of sensor data, combine (e.g., concatenate, interleave) the resulting tokens with the tokens of the text prompt to generate a sequence of tokens representing a tokenized multi-modal prompt, and issue the sequence of tokens as a prompt for the LLM(s) 180 via the inference server 170.

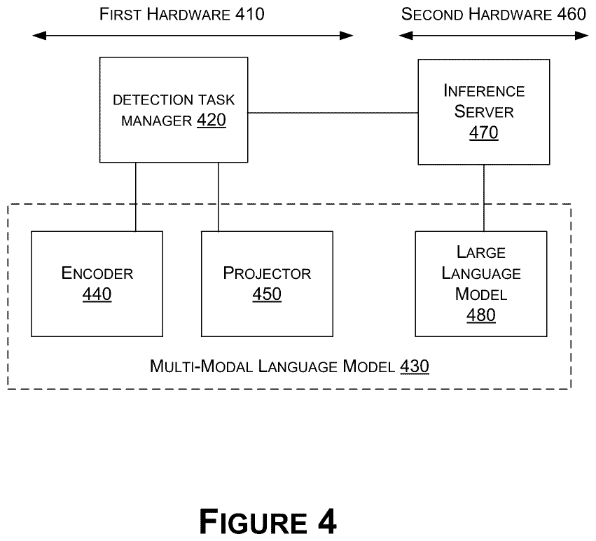

FIG. 4 is a block diagram illustrating an example multi-modal language model 430 (e.g., which may correspond to the multi-modal language model(s) 140 of FIG. 1). In this example implementation, the multi-modal language model 430 includes an encoder 440 (which may correspond to the encoder(s) 150 of FIG. 1) and a projector 450 (which may correspond to the projector(s) 160 of FIG. 1) hosted and executing on first hardware 410 (e.g., which may correspond to the SoC 110 of FIG. 1) and an LLM 480 (e.g., which may correspond to the LLM(s) 180 of FIG. 1) hosted and executing on second hardware 165 (e.g., which may correspond to the external hardware 165 of FIG. 1). As such, this is an example implementation in which a multi-modal language model (e.g., a VLM) may be split up and hosted by multiple devices.

In some embodiments, a detection task manager 420 (e.g., which may correspond to the detection task manager 120a of FIG. 1) may prompt the multi-modal language model 430 with a multi-modal prompt by applying first data (e.g., visual input data such one or more images, which may be sequentially applied) to the encoder 440 (e.g., a vison encoder for a VLM) to generate an embedding, applying the embedding(s) of the first data to the projector 450 to project the embedding(s) into corresponding tokens (e.g., visual tokens) in the same embedding space as the text tokens of the text prompt, combining the generated tokens with the text prompt (e.g., via concatenation, interleaving tokens of different modalities, etc.) into a sequence of tokens representing a tokenized multi-modal prompt, and issuing the tokenized multi-modal prompt (e.g., transmitting or streaming the sequence of tokens) as part of an inference request to the inference server 470 (e.g., which may correspond to the inference server 170 of FIG. 1) (e.g., via an API call such as an HTTP POST request to an API endpoint of the inference server 470). As such, the inference server 470 may provide the tokenized multi-modal prompt to the LLM 480 and return the LLM's response back to the detection task manager 420.

Returning to FIG. 1, as with other possible tasks described herein, the text portion of the multi-modal prompt may depend on the applicable task and/or the implementation. Generally, the detection task manager 120a may use any known prompt engineering technique (e.g., using system prompts, role-based prompts, instruction prompts, question prompts, multi-turn prompts, etc.) to provide designated questions and/or instructions to (e.g., the LLM(s) 180 of) the multi-modal language model(s) 140 corresponding to the applicable detection task. Example detection tasks (and corresponding sample questions) include DMS tasks such as driver distraction detection (“Is the driver distracted?,” “Is the driver looking on-road or offroad?,” “Is the driver using a phone?”), driver drowsiness detection (“Is the driver falling asleep or showing signs of drowsiness?”), driver out-of-position detection (“Is the driver seated correctly?,” “Are the driver's limbs in a safe position?,” “Is the driver leaning or slouched?”), hands-on-wheel detection (“Are both the driver's hands on the steering wheel?,” “Is at least one hand on the steering wheel? ”), and driver presence detection or identification (“Is there a driver in the vehicle?,” “Is the detected occupant the authorized driver?”); OMS tasks such as child or occupant presence detection or identification (“Is there an occupant in the vehicle?,” “Is there a child in the vehicle?,” “Is there an unattended child in the vehicle? ”), occupant classification (“Is there an occupant in the seat?,” “Is the occupant a child or an adult?,” “Is the occupant using a child safety seat?”), rear-facing child seat monitoring (e.g., “Is the baby properly secured in the car seat?,” “Is the baby awake?,” “Is the baby still sleeping?”), occupant out-of-position detection (“Is the occupant seated correctly?,” “Are the occupant's limbs in a safe position?”), distress detection (“Is the driver experiencing a medical emergency?,” “Is the driver exhibiting signs of emotional distress? ”), seatbelt usage detection (“Is the seatbelt fastened?,” “Is the seatbelt properly positioned?,” “Are all occupants using their seatbelts?”), and gesture recognition (“Is an occupant making a recognizable gesture?,” “What gesture is the occupant making?,” “Is the gesture intended to interact with the vehicle's system? ”); and exterior or other environmental sensing tasks such as sign detection or evaluation (“Is there a sign present?,” “What type of sign has been detected?,” “Is the detected sign visible and clear?”), parking space detection or evaluation (“Is there an available parking space?,” “Is the parking space large enough to accommodate the vehicle?”), trajectory evaluation (“Is the current trajectory safe?,” “Is the trajectory in compliance with traffic rules?”), lane detection (“Are the lane markings visible?,” “Is the vehicle centered within its lane or drifting towards the edges?,” “Is the vehicle departing from its lane?”), context-aware question answering of contextual inquiries to answer user questions about a scene (“What is the big building on the left?,” “What did that sign say?”), object-left-behind detection (“Is there an object left behind in the vehicle?,” “Where is the object located within the vehicle?,” “Is the object a [designated type of object]?”), suspicious activity monitoring (“Is there any movement around the vehicle?,” “Is someone approaching the vehicle?,” “Is there any unusual behavior detected near the vehicle?,” “Is there an attempt to open the doors or trunk?,” “Are there any unauthorized people around the vehicle?”), and/or others. Generally, a designated output format for sensor selection (e.g., a tag or other identifier representing the selected sensor) may be enforced in any suitable manner (e.g., using prompt engineering, post-processing, training, multiple inferences, etc.).

As such, the multi-modal language model(s) 140 may be prompted to evaluate the sensor (e.g., image) data and generate one or more responses evaluating a designated task based on the scene represented in the (e.g., selected ROI of the) sensor data, and a designated output format for a corresponding structured output (e.g., binary, JSON) may be enforced using any known technique (e.g., using prompt engineering, post-processing, training, multiple inferences, etc.). Generally, the output(s) of the multi-modal language model(s) 140 may include one or more fields that are constrained to designated classes or categories (categorical data) and/or one or more fields that are specified within a numerical range (continuous or numerical data). As such, the detection task manager 120a may provide the output(s) (or may decode and provide a representation of the output(s)) to corresponding control component(s) 190 to perform one or more responsive actions (e.g., issuing audible or visual alerts to refocus the driver, adjusting in-vehicle infotainment settings to minimize distractions, activating safety systems like adaptive cruise control or lane-keeping assistance, etc.).

Generally, the applicable control component(s) 190 may depend on the detection task and/or the implementation. Taking automotive applications as an example, in some embodiments, the control component(s) 190 are part of an ADAS such as the ADAS system 838 of FIG. 8C, and the control component(s) 190 may coordinate and/or manage one or more functions within the ADAS. Generally, the ADAS may use any known technique to assess the vehicle's surroundings, identify potential risks or hazards, and/or implement autonomous driving features such as adaptive cruise control, automatic emergency braking, lane-keeping assistance, and/or collision avoidance systems, to name a few examples. Taking DMS tasks such as driver drowsiness or distraction detection as an example, if the multi-modal language model(s) 140 detect the driver is not attentive or in a drive-ready position, the control component(s) 190 may trigger one or more alerts (auditory, visual, or haptic) to regain the driver's attention, adjust one or more driver assistance features such as adaptive cruise control (e.g., increase the following distance or reduce the vehicle's speed) or lane keeping assistance (e.g., be more proactive in correcting lane deviations), trigger the ADAS to execute one or more safety interventions (e.g., automatic braking, emergency steering, transition to autonomous driving mode), etc.

Taking some example OMS tasks, if the multi-modal language model(s) 140 detect the presence of an occupant, the control component(s) 190 may enable safety features such as airbags or seatbelt reminders, or activate systems such as climate control and/or infotainment. If the multi-modal language model(s) 140 detect a known occupant, the control component(s) 190 may adjust settings such as seat position or temperature to saved preferences. If the multi-modal language model(s) 140 classify an occupant as an adult or a child, the control component(s) 190 may adjust airbag deployment or child lock settings. If the multi-modal language model(s) 140 detect distress, the control component(s) 190 may trigger some emergency response (e.g., contacting emergency services, displaying or announcing emergency instructions). If the multi-modal language model(s) 140 detect a seat belt is not being worn, the control component(s) 190 may prevent the vehicle from starting, limit its speed, or issue a visual or auditory reminder to fasten the seat belt. If the multi-modal language model(s) 140 recognize a particular gesture, the control component(s) 190 may execute or trigger a corresponding function (e.g., adjusting volume, changing temperature, opening windows). If the multi-modal language model(s) 140 detect that a baby in a car seat woke up, the control component(s) 190 may trigger a corresponding visual or audible notification for the operator or other occupant, prompt for or accept input triggering soothing music or white noise, and/or otherwise.

Taking some other possible detection tasks as examples, if the multi-modal language model(s) 140 determine a candidate trajectory is safe, the control component(s) 190 may trigger the vehicle to take the candidate trajectory (and vice versa). If the multi-modal language model(s) 140 detect updated lane boundaries in the lane the vehicle is currently navigating, the control component(s) 190 may trigger one or more controls that maintain the position of the vehicle within the lane (e.g., lane keeping), alert the driver that the vehicle is starting to drift out of its lane without signaling, plan for or execute a lane change or an upcoming turn, etc. If the multi-modal language model(s) 140 answer a contextual inquiry about the environment, the control component(s) 190 may provide a visual or audible representation of the answer. If the multi-modal language model(s) 140 detect a (e.g., previously designated) object left behind (e.g., in response to detecting one or more of the occupants exiting the vehicle), the control component(s) 190 may issue an audible alert, trigger a notification via a mobile app, or otherwise issue a notification. If the multi-modal language model(s) 140 detect suspicious activity such as an attempted intrusion, the control component(s) 190 may alert the owner or occupant(s), notify authorities, and/or activate security measures such as locking doors or recording video footage. The foregoing detection tasks and corresponding controls are meant simply as non-limiting examples, and variations and other detection tasks may be implemented within the scope of the present disclosure.

In some embodiments, the multi-modal language model(s) 140 may be used to perform environmental (e.g., text) perception, for example, by evaluating signs represented in image data (e.g., one or more frames representing a single time slice or sampled frames from a video representing multiple time slices). In an example implementation involving parking sign comprehension and/or parking space evaluation, the control component(s) 190 (e.g., an ADAS) may identify candidate parking spaces using any known technique, and the multi-modal language model(s) 140 may be used to evaluate image data representing detected parking sign(s) and determine whether it is permissible and/or the cost to park in a candidate parking space. If the multi-modal language model(s) 140 determine(s) it is permissible to park in a candidate parking space, the control component(s) 190 may initiate parking in the candidate space or provide some real-time feedback indicating the determination (e.g., emphasizing permissible parking spaces on a map or visualization of the surrounding environment, triggering a visual or audible notification). Conversely, if the multi-modal language model(s) 140 determine it is not permissible to park in a candidate parking space, the control component(s) 190 may negate the candidate parking space or provide some real-time feedback indicating the determination.

Taking comprehension of a toll or restricted lane sign as an example, if the multi-modal language model(s) 140 determine it is permissible to merge into a restricted or toll lane (e.g., within a designated budget), the control component(s) 190 may initiate the merge. Conversely, if the multi-modal language model(s) 140 determine it is not permissible to merge into a restricted or toll lane (e.g., within a specified budget), the control component(s) 190 may determine not to initiate the merge. These are meant simply as examples of possible functions for the control component(s) 190 that may be implemented in automotive applications. Those of ordinary skill in the art will understand how to adapt the control component(s) 190 to other types of applications described here.

The multi-modal language model(s) 140 may be selected and/or trained using any known technique. For example, the multi-modal language model(s) 140 may include a pre-trained or foundational VLM (or other multi-modal language model) and/or LLM, and a training engine 195 may use any known technique to fine-tune the multi-modal language model(s) 140 to select a sensor stream, select region of interest, and/or perform any other designated task. A training dataset may be generated and/or collected in various ways, depending on the desired output. For example, sensor (e.g., image) data representing various scenes (e.g., depicting events that should and should not trigger selection of a desired sensor feed, depicting events that should and should not trigger selection of a desired ROI, events that span desired parameters for the multi-modal language model(s) 140 to support, etc.) may be used as input training data, and a corresponding target multi-modal language model(s) 140 output may be generated and used as ground truth training data.

An example training data point may associate a set of images representing different camera feeds (or other types of sensor data) in which one of the images includes a sign to be detected and/or interpreted, with corresponding ground truth data (e.g., text comprising one or more fields encoding categorical data and/or numerical data) representing a selection of the image that shows (or the corresponding sensor that observed) the sign. As such, the training engine 195 may use the training dataset to train the multi-modal language model(s) 140 using auto-regressive training. For example, the training engine 195 may prompt the multi-modal language model(s) 140 to sequentially predict one of the ground truth data points based on corresponding input data. Accordingly, the training engine 195 may train (e.g., fine-tune) the multi-modal language model(s) 140 to perform a desired task (e.g., selection of a sensor stream, selection of region of interest, and/or other designated task etc.)

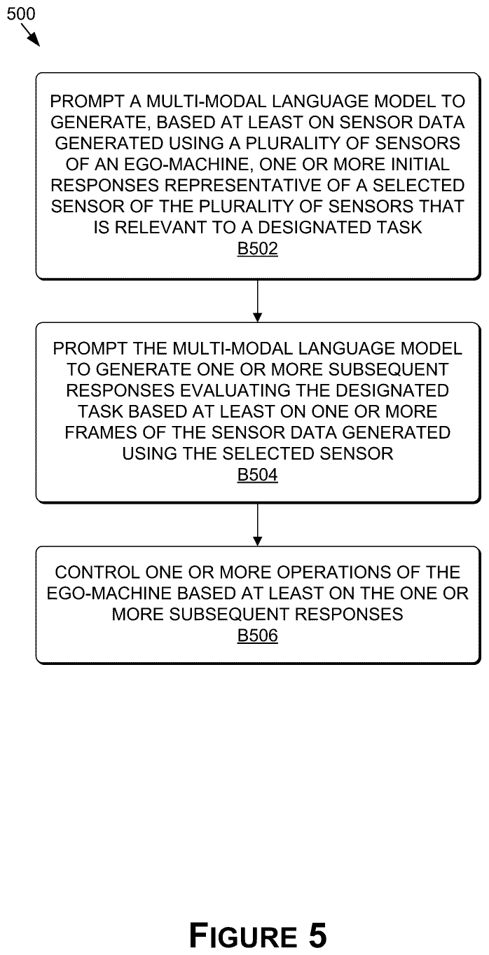

Now referring to FIGS. 5-7, each block of methods 500-700 and other methods described herein comprises a computing process that may be performed using any combination of hardware, firmware, and/or software. For instance, various functions may be carried out by a processor executing instructions stored in memory. The methods 500-700 may also be embodied as computer-usable instructions stored on computer storage media. The methods 500-700 may be provided by a standalone application, a standalone service, a hosted service (standalone or in combination with another hosted service), or a plug-in to another product, to name a few. In addition, the methods 500-700 are described, by way of example, with respect to the detection pipeline 100 of FIG. 1. However, these methods may additionally or alternatively be executed by any one system, or any combination of systems, including, but not limited to, those described herein.

FIG. 5 is a flow diagram showing a method 500 for sensor selection using a multi-modal language model, in accordance with some embodiments of the present disclosure. The method 500, at block B502, includes prompting—e.g., providing a text-, character-, or image-based instruction, query, or series of instructions or queries to—a multi-modal language model to generate, based at least on sensor data generated using a plurality of sensors of an ego-machine, one or more initial responses representative of a selected sensor of the plurality of sensors that is relevant to a designated task. For example, with respect to the detection pipeline 100 of FIG. 1, the stream selector 125a may collect or otherwise identify one or more frames of sensor data from each potentially relevant sensor, may fit (e.g., compress and/or crop) (e.g., each of) the frame(s) to a supported input resolution of (e.g., the encoder(s) 150 of) the multi-modal language model(s) 140, and may prompt the multi-modal language model(s) 140 (e.g., via the inference coordinator 135a and the inference server 170) to identify one of the sensors for a designated task based on the fitted frames of sensor data.

The method 500, at block B504, includes prompting the multi-modal language model to generate one or more subsequent responses evaluating the designated task based at least on one or more frames of the sensor data generated using the selected sensor. For example, with respect to the detection pipeline 100 of FIG. 1, the multi-modal language model(s) 140 provide a response identifying a selected sensor that is relevant to the designated task, upon which the stream selector 125a may prompt the multi-modal language model(s) 140 to evaluate the applicable detection task (e.g., whether one or more target conditions of the applicable detection task are present, performing scene or text perception, etc.) using a (e.g., current or subsequent, higher resolution) frame of sensor data from the identified sensor.

The method 500, at block B506, includes controlling one or more operations of the ego-machine based at least on the one or more subsequent responses. For example, with respect to the detection pipeline 100 of FIG. 1, the multi-modal language model(s) 140 (e.g., the LLM(s) 180) may return a response indicating the result(s) of the requested detection task. As such, the detection task manager 120a may provide a corresponding control component(s) 190 with a representation of the result(s), and the control component(s) 190 may take some responsive action.

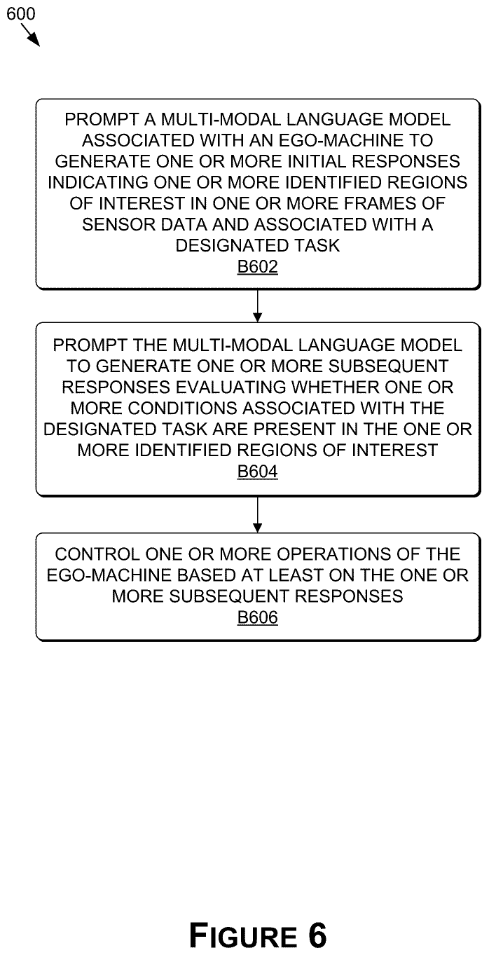

FIG. 6 is a flow diagram showing a method 600 for identifying one or more regions of interest using a multi-modal language model, in accordance with some embodiments of the present disclosure. The method 600, at block B602, includes prompting a multi-modal language model associated with an ego-machine to generate one or more initial responses indicating one or more identified regions of interest in one or more frames of sensor data and associated with a designated task. For example, with respect to the detection pipeline 100 of FIG. 1, the ROI selector 130a may collect or otherwise identify one or more frames of sensor data from a sensor feed (e.g., of a selected sensor, of a designated sensor) for a designated detection task, the ROI selector 130a may fit (e.g., compress and/or crop) (e.g., each of) the frame(s) to a supported input resolution of (e.g., the encoder(s) 150 of) the multi-modal language model(s) 140, and the ROI selector 130a may prompt the multi-modal language model(s) 140 (e.g., via the inference coordinator 135a and the inference server 170) to identify a region of interest for a designated task based on the fitted frame(s) of sensor data.

The method 600, at block B604, includes prompting the multi-modal language model to generate one or more subsequent responses evaluating whether one or more conditions associated with the designated task are present in the one or more identified regions of interest. For example, with respect to the detection pipeline 100 of FIG. 1, the multi-modal language model(s) 140 may provide a response identifying one or more ROIs relevant to a designated task, upon which the ROI selector 130a may parse the response, determine that it identifies one or more ROIs, extract a representation of the identified ROI(s), and may prompt the multi-modal language model(s) 140 to evaluate the applicable detection task (e.g., whether one or more target conditions of the applicable detection task are present, performing scene or text perception, etc.) using the identified ROI (e.g., at full resolution or fitted to the input resolution of the multi-modal language model(s) 140).

The method 600, at block B606, includes controlling one or more operations of the ego-machine based at least on the one or more subsequent responses. For example, with respect to the detection pipeline 100 of FIG. 1, the multi-modal language model(s) 140 (e.g., the LLM(s) 180) may return a response indicating the result(s) of the requested detection task. As such, the detection task manager 120a may provide a corresponding control component(s) 190 with a representation of the result(s), and the control component(s) 190 may take some responsive action.

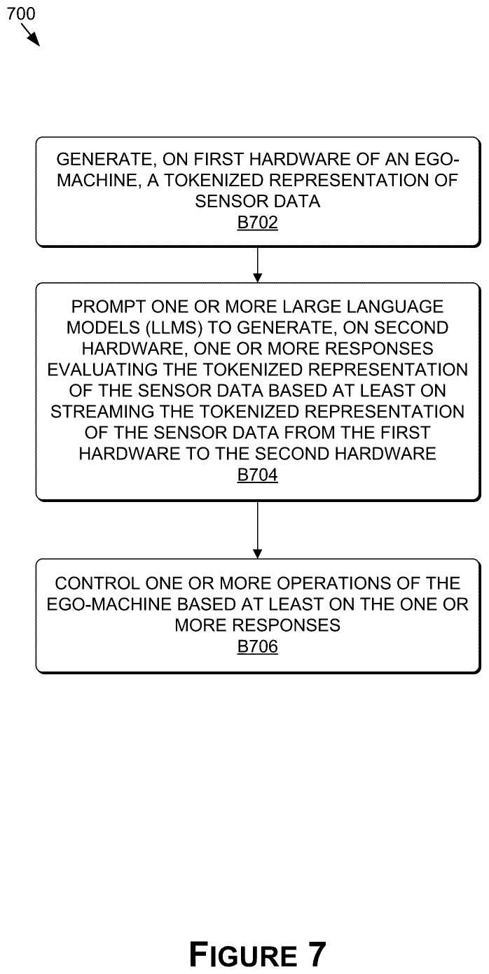

FIG. 7 is a flow diagram showing a method 700 for streaming a tokenized representation of sensor data, in accordance with some embodiments of the present disclosure. The method 700, at block B702, includes generating, on first hardware of an ego-machine, a tokenized representation of sensor data. For example, with respect to the detection pipeline 100 of FIG. 1, the detection task manager 120a may generate and issue (e.g., to the inference coordinator 135a) a multi-modal prompt comprising a representation of one or more (e.g., selected ROI within one or more) frame(s) of sensor data (e.g., resized, cropped, and/or sampled frames) and a text prompt that instructs, primes, or otherwise triggers the multi-modal language model(s) 140 to evaluate a designated task based on the frame(s) of sensor data. The inference coordinator 135a may apply a representation of the frame(s) of sensor data to the encoder(s) 150 to generate an encoded representation of the frame(s) of sensor data, and apply the encoded representation of the frame(s) to the projector(s) 160 to tokenize the encoded representation of the frame(s) of sensor data.

The method 700, at block B704, includes prompting one or more large language models (LLMs) to generate, on second hardware, one or more responses evaluating the tokenized representation of the sensor data based at least on streaming the tokenized representation of the sensor data from the first hardware to the second hardware. For example, with respect to the detection pipeline 100 of FIG. 1, the inference coordinator 135a may combine (e.g., concatenate, interleave) the resulting tokens generated by the projector(s) 160 with the tokens of the issued text prompt to generate a sequence of tokens representing a tokenized multi-modal prompt, and may stream the sequence of tokens as a prompt for the LLM(s) 180 via the inference server 170.

The method 700, at block B706, includes controlling one or more operations of the ego-machine based at least on the one or more responses. For example, with respect to the detection pipeline 100 of FIG. 1, the LLM(s) 180 may return a response indicating the result(s) of the requested detection task. As such, the detection task manager 120a may provide a corresponding control component(s) 190 with a representation of the result(s), and the control component(s) 190 may take some responsive action.

The systems and methods described herein may be used by—or may be used in combination with—without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), language model applications (e.g., large language models (LLMs), vision language models (VLMs), etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some embodiments, the systems and methods described herein may be performed within a simulation environment (e.g., NVIDIA's DriveSIM) using simulated data (e.g., simulated sensor data of simulated sensors of a simulated machine). For example, simulated (or virtual) sensor data (e.g., images of a simulated environment such as highway or warehouse environment generated from the perspective of one or more simulated sensors of a simulated ego-machine) may be applied to a multi-modal language model (e.g., a VLM) to perform one or more tasks (e.g., selection of a simulated sensor feed for subsequent analysis, selection and/or refinement of one or more ROIs for subsequent analysis, and/or some designated monitoring or detection task which may be performed using a selected simulated sensor feed and/or ROI(s)), and the multi-modal language model's response may be used to control the simulated ego-machine within the simulated environment. These simulated operations may be used to test performance of the underlying algorithms, systems, and/or processes prior to deploying them in the real-world. In some instances, the simulation may be used to generate synthetic training data—e.g., images of a simulated environment generated from the perspective of one or more simulated sensors of a simulated ego-machine, and the synthetic training data (in addition or as an alternative to real-world data) may be used to train a multi-modal language model (e.g., a VLM). In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

### Example Autonomous Vehicle

FIG. 8A is an illustration of an example autonomous or semi-autonomous vehicle or machine 800, in accordance with some embodiments of the present disclosure. The autonomous or semi-autonomous vehicle or machine 800 (alternatively referred to herein as the “vehicle 800,” “machine 800,” “ego-vehicle 800,” “ego-machine 800,” “robot 800,” etc.) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1—Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to allow the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to allow autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LiDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), one or more occupant monitoring system (OMS) sensor(s) 801 (e.g., one or more interior cameras), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

Cameras with a field of view that include portions of the interior environment within the cabin of the vehicle 800 (e.g., one or more OMS sensor(s) 801) may be used as part of an occupant monitoring system (OMS) such as, but not limited to, a driver monitoring system (DMS). For example, OMS sensors (e.g., the OMS sensor(s) 801) may be used (e.g., by the controller(s) 836) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation allowing any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 804 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4MB of SRAM), may allow the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. Pat. No. 10,885,698, issued on Jan. 5, 2021. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LiDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 816 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to allow communication with peripherals, audio codecs, power management, and/or other devices. The SoC(s) 804 may be used to process data from cameras (e.g., connected over Gigabit Multimedia Serial Link and Ethernet), sensors (e.g., LiDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to allow wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated using the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LiDAR sensor(s) 864. The LiDAR sensor(s) 864 may be used for object and pedestrian detection, emergency braking, collision avoidance, and/or other functions. The LiDAR sensor(s) 864 may be functional safety level ASIL B. In some examples, the vehicle 800 may include multiple LiDAR sensors 864 (e.g., two, four, six, etc.) that may use Ethernet (e.g., to provide data to a Gigabit Ethernet switch).

In some examples, the LiDAR sensor(s) 864 may be capable of providing a list of objects and their distances for a 360-degree field of view. Commercially available LiDAR sensor(s) 864 may have an advertised range of approximately 800 m, with an accuracy of 2 cm-3 cm, and with support for a 800 Mbps Ethernet connection, for example. In some examples, one or more non-protruding LiDAR sensors 864 may be used. In such examples, the LiDAR sensor(s) 864 may be implemented as a small device that may be embedded into the front, rear, sides, and/or corners of the vehicle 800. The LiDAR sensor(s) 864, in such examples, may provide up to a 120-degree horizontal and 35-degree vertical field-of-view, with a 200 m range even for low-reflectivity objects. Front-mounted LiDAR sensor(s) 864 may be configured for a horizontal field of view between 45 degrees and 135 degrees. FIG. 8B illustrates example long-range and short-range horizontal fields-of-view for a LiDAR sensor 864 with an example mounting location above the windshield, but other configurations such as those that include a grille-mounted LiDAR sensor 864 (e.g., as illustrated in FIG. 8A) and/or a roof-mounted LiDAR scanner (e.g., for a data collection vehicle) are possible.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 800. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may allow the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LiDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. As such, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(D) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/VLM/MMLM/etc. with external knowledge, so that answers to specific questions or queries or requests are more relevant—such as in a case where specific knowledge is required. The RAG component 992 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Inference and Training Logic

One or more embodiments may be implemented using inference and/or training logic to perform inferencing and/or training operations. Details regarding inference and/or training logic are provided below.

In at least one embodiment, inference and/or training logic may include, without limitation, code and/or data storage to store forward and/or output weight and/or input/output data, and/or other parameters to configure. neurons or layers of a neural network trained and/or used for inferencing in aspects of one or more embodiments. In at least one embodiment, training logic may include, or be coupled to code and/or data storage to store graph code or other software to control timing and/or order, in which weight and/or other parameter information is to be loaded to configure., logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage may be included with other on-chip or off-chip data storage, including a processor's L1, L2, or L3 cache or system memory.

In at least one embodiment, any portion of code and/or data storage may be internal or external to one or more processors or other hardware logic devices or circuits. In at least one embodiment, code and/or data storage may be cache memory, dynamic randomly addressable memory (“DRAM”), static randomly addressable memory (“SRAM”), non-volatile memory (e.g., Flash memory), or other storage. In at least one embodiment, choice of whether code and/or data storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic may include, without limitation, a code and/or data storage to store backward and/or output weight and/or input/output data corresponding to neurons or layers of a neural network trained and/or used for inferencing in aspects of one or more embodiments. In at least one embodiment, code and/or data storage stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage to store graph code or other software to control timing and/or order, in which weight and/or other parameter information is to be loaded to configure., logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage may be included with other on-chip or off-chip data storage, including a processor's L1, L2, or L3 cache or system memory. In at least one embodiment, any portion of code and/or data storage may be internal or external to on one or more processors or other hardware logic devices or circuits. In at least one embodiment, code and/or data storage may be cache memory, DRAM, SRAM, non-volatile memory (e.g., Flash memory), or other storage. In at least one embodiment, choice of whether code and/or data storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage and code and/or data storage may be separate storage structures. In at least one embodiment, code and/or data storage and code and/or data storage may be same storage structure. In at least one embodiment, code and/or data storage and code and/or data storage may be partially same storage structure and partially separate storage structures. In at least one embodiment, any portion of code and/or data storage and code and/or data storage may be included with other on-chip or off-chip data storage, including a processor's L1, L2, or L3 cache or system memory.

In at least one embodiment, inference and/or training logic may include, without limitation, one or more arithmetic logic unit(s) (“ALU(s)”), including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage that are functions of input/output and/or weight parameter data stored in code and/or data storage and/or code and/or data storage. In at least one embodiment, activations stored in activation storage are generated according to linear algebraic and or matrix-based mathematics performed by ALU(s) in response to performing instructions or other code, wherein weight values stored in code and/or data storage and/or code and/or data storage are used as operands along with other values, such as bias values, gradient information, momentum values, or other parameters or hyperparameters, any or all of which may be stored in code and/or data storage or code and/or data storage or another storage on or off-chip.

In at least one embodiment, ALU(s) are included within one or more processors or other hardware logic devices or circuits, whereas in another embodiment, ALU(s) may be external to a processor or other hardware logic device or circuit that uses them (e.g., a co-processor). In at least one embodiment, ALU(s) may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage, code and/or data storage, and activation storage may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage may be cache memory, DRAM, SRAM, non-volatile memory (e.g., Flash memory), or other storage. In at least one embodiment, activation storage may be completely or partially within or external to one or more processors or other logical circuits. In at least one embodiment, choice of whether activation storage is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (“CPU”) hardware, graphics processing unit (“GPU”) hardware or other hardware, such as field programmable gate arrays (“FPGAs”).

In at least one embodiment, inference and/or training logic may include, without limitation, hardware logic in which computational resources are dedicated or otherwise exclusively used in conjunction with weight values or other information corresponding to one or more layers of neurons within a neural network. In at least one embodiment, inference and/or training logic may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (CPU) hardware, graphics processing unit (GPU) hardware or other hardware, such as field programmable gate arrays (FPGAs). In at least one embodiment, inference and/or training logic includes, without limitation, code and/or data storage and code and/or data storage, which may be used to store code (e.g., graph code), weight values and/or other information, including bias values, gradient information, momentum values, and/or other parameter or hyperparameter information. In at least one embodiment, each of code and/or data storage and code and/or data storage is associated with a dedicated computational resource, such as computational hardware and computational hardware. In at least one embodiment, each of computational hardware and computational hardware comprises one or more ALUs that perform mathematical functions, such as linear algebraic functions, only on information stored in code and/or data storage and code and/or data storage, respectively, result of which is stored in activation storage.

In at least one embodiment, each of code and/or data storage and corresponding computational hardware correspond to different layers of a neural network, such that resulting activation from one storage/computational pair of code and/or data storage and computational hardware is provided as an input to storage/computational pair of code and/or data storage and computational hardware, in order to mirror conceptual organization of a neural network. In at least one embodiment, each of storage/computational pairs may correspond to more than one neural network layer. In at least one embodiment, additional storage/computation pairs (not shown) subsequent to or in parallel with storage computation pairs may be included in inference and/or training logic.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in the appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims. The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:

Clause 1. One or more processors comprising processing circuitry to provide a prompt to a multi-modal language model to generate, based at least on sensor data generated using a plurality of sensors of an ego-machine, one or more initial responses representative of a selected sensor of the plurality of sensors that is relevant to a designated task.

Clause 2. The one or more processors of clause 1, wherein the processing circuitry is further to provide a prompt to the multi-modal language model to generate one or more subsequent responses evaluating the designated task based at least on one or more frames of the sensor data generated using the selected sensor and applied to the multi-modal language model.

Clause 3. The one or more processors of clause 1 or 2, wherein the processing circuitry is further to control one or more operations of the ego-machine based at least on the one or more subsequent responses.

Clause 4. The one or more processors of clause 1, 2 or 3, wherein the processing circuitry is further to increase an input resolution of at least one frame of the one or more frames of the sensor data applied to the multi-modal language model based at least on the multi-modal language model generating the one or more initial responses representative of the selected sensor.

Clause 5. The one or more processors of clause 1, 2 or 3, wherein the processing circuitry is further to prompt the multi-modal language model to generate the one or more initial responses based at least on at least one first frame of the one or more frames of the sensor data, and prompt the multi-modal language model to generate the one or more subsequent responses based at least on at least one second frame of the one or more frames of the sensor data, the at least one first frame having a first resolution and the at least one second frame having a second resolution that is higher than the first resolution.

Clause 6. The one or more processors of clause 1, 2 or 3, wherein the processing circuitry is further to increase a rate of providing prompts to the multi-modal language model to generate additional subsequent responses based at least on the multi-modal language model identifying the selected sensor.

Clause 7. The one or more processors of clause 1, 2 or 3, wherein the processing circuitry is further to provide a prompt to the multi-modal language model to generate the one or more initial responses representative of the selected sensor based at least on applying at least one of: a tiled representation of a plurality of frames of sensor data generated using the plurality of sensors; or one or more compressed representations of a plurality of frames of sensor data generated using the plurality of sensors.

Clause 8. The one or more processors of clause 1, 2 or 3, wherein the processing circuitry is further to prompt the multi-modal language model to identify, within the one or more frames of the sensor data generated using the selected sensor, one or more regions of interest associated with the designated task.

Clause 9. The one or more processors of clause 1, 2 or 3, wherein the sensor data comprises image data generated using a plurality of cameras of the ego-machine, the multi-modal language model comprises a vision language model (VLM), and the one or more processors are further to provide a prompt to the VLM to generate the one or more initial responses representative of a selected camera of the plurality of cameras that is relevant to the designated task.

Clause 10. The one or more processors of clause 1, 2 or 3, wherein the one or more subsequent responses by the multi-modal language model indicate one or more results of performing one or more computer vision tasks using the multi-modal language model, at least one computer vision task of the one or more computer vision tasks including at least one of: driver drowsiness detection, driver distraction detection, driver out-of-position detection, driver or occupant identification, seatbelt usage detection, occupant presence detection, occupant classification, child presence detection, gesture recognition, sign recognition, context-aware question answering, recognition of one or more objects left behind, or suspicious activity monitoring.

Clause 11. The one or more processors of clause 1, 2 or 3, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 12. A method comprising based at least on a multi-modal language model generating one or more initial responses indicating a selected sensor of an ego-machine is relevant to a designated task, prompting the multi-modal language model to generate one or more subsequent responses evaluating the designated task based at least on one or more frames of sensor data generated using the selected sensor and applied to the multi-modal language model.

Clause 13. The method of clause 12, further comprising controlling one or more operations of the ego-machine based at least on the one or more subsequent responses.

Clause 14. The method of clause 12 or 13, further comprising increasing an input resolution of at least one frame of one or more frames of the sensor data applied to the multi-modal language model based at least on the multi-modal language model generating the one or more initial responses indicating the selected sensor.

Clause 15. The method of clause 12 or 13, further comprising prompting the multi-modal language model to generate the one or more initial responses based at least on at least one first frame of one or more frames of the sensor data, and prompting the multi-modal language model to generate the one or more subsequent responses based at least on at least one second frame of the one or more frames the sensor data, the at least one first frame having a first resolution and the at least one second frame having a second resolution that is higher than the first resolution.

Clause 16. The method of clause 12 or 13, further comprising increasing a rate of providing prompts to the multi-modal language model based at least on the multi-modal language model generating the one or more initial responses identifying the selected sensor.

Clause 17. The method of clause 12 or 13, further comprising providing a prompt to the multi-modal language model to generate the one or more initial responses representative of the selected sensor based at least on applying at least one of: a tiled representation of a plurality of frames of sensor data generated using a plurality of sensors of the ego-machine to the multi-modal language model; or one or more compressed representations of a plurality of frames of sensor data generated using a plurality of sensors of the ego-machine to the multi-modal language model.

Clause 18. The method of clause 12 or 13, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 19. A system comprising one or more processors to control, within a simulation of an environment that is rendered using one or more light transport simulation algorithms, one or more operations of a simulated ego-machine in the simulated environment based at least on one or more outputs of one or more multi-modal language models, the one or more outputs generated based at least on the multi-modal language model evaluating whether one or more conditions associated with a designated task are present in one or more frames of simulated sensor data generated using a selected simulated sensor, the selected simulated sensor being selected from a plurality of simulated sensors based at least on the multi-modal language model evaluating a plurality of frames of simulated sensor data generated using the plurality of simulated sensors of the simulated ego-machine.

Clause 20. The system of clause 19, wherein the simulation is generated, at least in part, using a three-dimensional (3D) content collaboration platform for 3D assets.

Clause 21. The system of clause 20, wherein one or more files of the 3D content collaboration platform for 3D assets uses an OpenUSD format.

Clause 22. The system of clause 19, wherein the evaluating whether one or more conditions associated with a designated task are present in one or more frames of simulated sensor data comprises providing one or more text prompts to the multi-modal language model to generate one or more responses to evaluate a presence of the one or more conditions associated with the designated task based at least on one or more frames of generated simulated sensor data corresponding to the selected simulated sensor.

Clause 23. The system of clause 19, wherein at least one multi-modal language model of the one or more multi-modal language models is implemented in at least one processing node of a plurality of processing nodes of a data center and accessible to one or more remote clients via at least one of an application programming interface (API), or an application plug-in.

Clause 24. One or more processors comprising processing circuitry to prompt a multi-modal language model associated with an ego-machine to generate one or more initial responses associated with a designated task and indicating one or more identified regions of interest in one or more frames of sensor data applied to the multi-modal language model.

Clause 25. The one or more processors of clause 24, wherein the processing circuitry is further to prompt the multi-modal language model to generate one or more subsequent responses indicating an evaluation of whether one or more conditions associated with the designated task are present in any of the one or more identified regions of interest.

Clause 26. The one or more processors of clause 24 or 25, wherein the processing circuitry is further to control one or more operations of the ego-machine based at least on the one or more subsequent responses.

Clause 27. The one or more processors of clause 24, 25 or 26, wherein the processing circuitry is further to increase an input resolution of at least one frame of the one or more frames of sensor data applied to the multi-modal language model based at least on the multi-modal language model generating the one or more initial responses indicating the one or more identified regions of interest.

Clause 28. The one or more processors of clause 24, 25 or 26, wherein one or more identified regions of interest identified by the multi-modal language model have a resolution that corresponds to a maximum input resolution supported by the multi-modal language model.

Clause 29. The one or more processors of clause 24, 25 or 26, wherein the processing circuitry is further to iteratively prompt the multi-modal language model to refine the one or more identified regions of interest within the one or more frames of sensor data.

Clause 30. The one or more processors of clause 24, 25 or 26, wherein the processing circuitry is further to iteratively prompt the multi-modal language model to generate the one or more initial responses indicating the one or more identified regions of interest based at least on applying successive frames of the sensor data representing successive time slices to the multi-modal language model.

Clause 31. The one or more processors of clause 24, 25 or 26, wherein the processing circuitry is further to prompt the multi-modal language model to evaluate whether the one or more conditions are present in the one or more identified regions of interest based at least on the one or more initial responses generated by the multi-modal language model indicating at least a threshold measure of confidence in the one or more identified regions of interest.

Clause 32. The one or more processors of clause 24, 25 or 26, wherein the processing circuitry is further to apply, based at least on the one or more initial responses generated by the multi-modal language model indicating less than a threshold measure of confidence in the one or more identified regions of interest, a representation of a subsequent frame of the sensor data representing a subsequent time slice to the multi-modal language model.

Clause 33. The one or more processors of clause 24, 25 or 26, wherein the processing circuitry is further to increase a rate of prompting the multi-modal language model based at least on the multi-modal language model indicating the one or more identified regions of interest.

Clause 34. The one or more processors of clause 24, 25 or 26, wherein the processing circuitry is further to prompt the multi-modal language model to generate the one or more initial responses based at least on periodically applying successive frames of the sensor data representing successive time slices to the multi-modal language model until the multi-modal language model identifies the one or more identified regions of interest.

Clause 35. The one or more processors of clause 24, 25 or 26, wherein the designated task comprises at least one computer vision task, and one or more subsequent responses by the multi-modal language model indicate one or more results of the at least one computer vision task, the at least one computer vision task comprising at least one of: driver drowsiness detection, driver distraction detection, driver out-of-position detection, driver or occupant identification, seatbelt usage detection, occupant presence detection, occupant classification, child presence detection, gesture recognition, sign recognition, context-aware question answering, recognition of one or more objects left behind, or suspicious activity monitoring.

Clause 36. The one or more processors of clause 24, 25 or 26, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 37. A method comprising based at least on a multi-modal language model generating one or more initial responses associated with a designated task and indicating one or more identified regions of interest in one or more frames of sensor data of an ego-machine, prompting the multi-modal language model to generate one or more subsequent responses evaluating whether one or more conditions associated with the designated task are present in the one or more identified regions of interest.

Clause 38. The method of clause 37, further comprising controlling one or more operations of the ego-machine based at least on the one or more subsequent responses.

Clause 39. The method of clause 37 or 38, further comprising increasing an input resolution of at least one frame of the one or more frames of sensor data applied to the multi-modal language model based at least on the multi-modal language model generating the one or more initial responses indicating the one or more identified regions of interest.

Clause 40. The method of clause 37 or 38, wherein at least one frame of the one or more frames of sensor data depicting the one or more identified regions of interest identified by the multi-modal language model have a resolution that corresponds to a maximum input resolution supported by the multi-modal language model.

Clause 41. The method of clause 37 or 38, further comprising iteratively prompting the multi-modal language model to refine the one or more identified regions of interest within the one or more frames of sensor data.

Clause 42. The method of clause 37 or 38, further comprising iteratively prompting the multi-modal language model to generate the one or more initial responses indicating the one or more identified regions of interest based at least on applying successive frames of the sensor data representing successive time slices to the multi-modal language model.

Clause 43. The method of clause 37 or 38, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 44. A system comprising one or more processors to control, within a simulation that is rendered using one or more light transport simulation algorithms, one or more operations of a simulated ego-machine based at least on one or more outputs of one or more multi-modal language models, the one or more outputs generated based at least on applying one or more frames of simulated sensor data to the multi-modal language model and using the multi-modal language model to evaluate whether one or more conditions associated with a designated task are present in one or more regions of interest of the one or more frames of simulated sensor data, the one or more regions of interest identified in one or more initial outputs of the one or more multi-modal language models.

Clause 45. The system of clause 44, wherein the simulation is generated, at least in part, using a three-dimensional (3D) content collaboration platform for 3D assets.

Clause 46. The system of clause 44, wherein the 3D content collaboration platform for 3D assets uses OpenUSD.

Clause 47. One or more processors comprising processing circuitry to stream, from a first hardware platform to a second hardware platform, a tokenized representation of sensor data generated using the first hardware platform.

Clause 48. The one or more processors of clause 47, wherein the processing circuitry is further to prompt one or more large language models (LLMs) executed using the second hardware platform to evaluate the tokenized representation of the sensor data and to generate one or more responses based at least on the tokenized representation, wherein the tokenized representation is streamed from the first hardware platform to the second hardware platform.

Clause 49. The one or more processors of clause 47 or 48, wherein the processing circuitry is further to control one or more operations of an ego-machine based at least on the one or more responses.

Clause 50. The one or more processors of clause 47, 48 or 49, wherein the processing circuitry is further to generate the tokenized representation of the sensor data using a first set of one or more multi-modal language models executed using the first hardware platform, and to generate the one or more responses using a second set of the one or more multi-modal language models comprising the one or more LLMs executed using the second hardware platform.

Clause 51. The one or more processors of clause 47, 48 or 49, wherein the first hardware platform comprises an in-vehicle system-on-chip, and the processing circuitry is further to generate the tokenized representation of the sensor data using an encoder and a projector of a multi-modal language model executed using the in-vehicle system-on-chip.

Clause 52. The one or more processors of clause 47, 48 or 49, wherein the one or more LLMs executed using the second hardware platform comprise a first portion of a plurality of multi-modal language models, wherein the processing circuitry is further to execute a second portion of the plurality of multi-modal language models using the first hardware platform, and the second hardware platform comprises at least one of a graphics processing unit (GPU) or an AI accelerator that is external to the first hardware platform.

Clause 53. The one or more processors of clause 47, 48 or 49, wherein the first hardware platform comprises an in-vehicle system-on-chip (SoC), and the processing circuitry is further to stream the tokenized representation of the sensor data is streamed from the SoC over one or more network connections to the one or more LLMs executed using the second hardware platform.

Clause 54. The one or more processors of clause 47, 48 or 49, wherein the processing circuitry is further to generate the tokenized representation of the sensor data using the first hardware platform using a vision encoder and projector of a vision language model that includes the one or more LLMs executed using the second hardware platform.

Clause 55. The one or more processors of clause 47, 48 or 49, wherein the processing circuitry is further to prompt the one or more LLMs based at least on submitting a request comprising the tokenized representation of the sensor data from the first hardware platform to an application programming interface endpoint of an inference server executed using the second hardware platform.

Clause 56. The one or more processors of clause 47, 48 or 49, wherein the sensor data comprises image data to encode, generate, and prompt the one or more LLMs to evaluate the tokenized representation of the sensor data without compressing and decompressing the sensor data.

Clause 57. The one or more processors of clause 47, 48 or 49, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing the one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 58. A method comprising controlling one or more operations of an ego-machine based at least on one or more outputs of one or more large language models (LLMs) of one or more multi-modal language models, the one or more outputs generated based at least on a tokenized representation of sensor data streamed from a first chip used to execute a first portion of the one or more multi-modal language models that generated the tokenized representation to a second chip used to execute the one or more LLMs.

Clause 59. The method of clause 58, further comprising generating the tokenized representation of the sensor data using a first portion of the one or more multi-modal language models executed using the first chip, and generating the one or more outputs using a second portion of the one or more multi-modal language models comprising the one or more LLMs executed using the second chip.

Clause 60. The method of clause 58, further comprising generating the tokenized representation of the sensor data using an encoder and a projector of a multi-modal language model executed using an in-vehicle system-on-chip.

Clause 61. The method of clause 58, further comprising executing the one or more LLMs of the one or more multi-modal language models on at least one of a graphics processing unit (GPU) or an AI accelerator that is external to the first chip used to execute at least a portion of the one or more multi-modal language models.

Clause 62. The method of clause 58, wherein the first chip comprises an in-vehicle system-on-chip (SoC), and the tokenized representation of the sensor data is streamed from the SoC over one or more network connections to the one or more LLMs executed using the second chip.

Clause 63. The method of clause 58, further comprising generating the tokenized representation of the sensor data using the first chip comprises using a vision encoder and a projector of a vision language model that includes the one or more LLMs executed using the second chip.

Clause 64. The method of clause 58, further comprising prompting the one or more LLMs based at least on submitting a request comprising the tokenized representation of the sensor data from the first chip to an application programming interface endpoint of an inference server executed using the second chip.

Clause 65. The method of clause 58, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing the one or more large language models (LLMs); a system implementing one or more vision language models (VLMs); a system implementing the one or more multi-modal language models; a system for generating synthetic data; a system for generating synthetic data using AI; a system for performing one or more generative AI operations; a system incorporating one or more virtual machines (VMs); a system implemented at least partially in a data center; or a system implemented at least partially using cloud computing resources.

Clause 66. A system comprising one or more processors to control, within a simulation that is rendered using one or more light transport simulation algorithms, one or more operations of a simulated ego-machine based at least on one or more outputs of one or more multi-modal language models, the one or more outputs generated based at least on a tokenized representation of simulated sensor data streamed from a first hardware platform used to generate the tokenized representation to a second hardware platform used to execute one or more large language models (LLMs) of the one or more multi-modal language models.

Clause 67. The system of clause 66, wherein the simulation is generated, at least in part, using a three-dimensional (3D) content collaboration platform for 3D assets.

Clause 68. The system of clause 66, wherein the 3D content collaboration platform for 3D assets uses OpenUSD.

What is claimed is:

1. One or more processors comprising processing circuitry to:
provide a prompt to a multi-modal language model to generate, based at least on sensor data generated using a plurality of sensors of an ego-machine, one or more initial responses representative of a selected sensor of the plurality of sensors that is relevant to a designated task;
provide a prompt to the multi-modal language model to generate one or more subsequent responses evaluating the designated task based at least on one or more frames of the sensor data generated using the selected sensor and applied to the multi-modal language model; and
control one or more operations of the ego-machine based at least on the one or more subsequent responses.

2. The one or more processors of claim 1, wherein the processing circuitry is further to increase an input resolution of at least one frame of the one or more frames of the sensor data applied to the multi-modal language model based at least on the multi-modal language model generating the one or more initial responses representative of the selected sensor.

3. The one or more processors of claim 1, wherein the processing circuitry is further to prompt the multi-modal language model to generate the one or more initial responses based at least on at least one first frame of the one or more frames of the sensor data, and prompt the multi-modal language model to generate the one or more subsequent responses based at least on at least one second frame of the one or more frames of the sensor data, the at least one first frame having a first resolution and the at least one second frame having a second resolution that is higher than the first resolution.

4. The one or more processors of claim 1, wherein the processing circuitry is further to increase a rate of providing prompts to the multi-modal language model to generate additional subsequent responses based at least on the multi-modal language model identifying the selected sensor.

5. The one or more processors of claim 1, wherein the processing circuitry is further to provide a prompt to the multi-modal language model to generate the one or more initial responses representative of the selected sensor based at least on applying at least one of:
a tiled representation of a plurality of frames of sensor data generated using the plurality of sensors; or
one or more compressed representations of a plurality of frames of sensor data generated using the plurality of sensors.

6. The one or more processors of claim 1, wherein the processing circuitry is further to prompt the multi-modal language model to identify, within the one or more frames of the sensor data generated using the selected sensor, one or more regions of interest associated with the designated task.

7. The one or more processors of claim 1, wherein the sensor data comprises image data generated using a plurality of cameras of the ego-machine, the multi-modal language model comprises a vision language model (VLM), and the one or more processors are further to provide a prompt to the VLM to generate the one or more initial responses representative of a selected camera of the plurality of cameras that is relevant to the designated task.

8. The one or more processors of claim 1, wherein the one or more subsequent responses by the multi-modal language model indicate one or more results of performing one or more computer vision tasks using the multi-modal language model, at least one computer vision task of the one or more computer vision tasks including at least one of:
driver drowsiness detection,
driver distraction detection,
driver out-of-position detection,
driver or occupant identification,
seatbelt usage detection,
occupant presence detection,
occupant classification,
child presence detection,
gesture recognition,
sign recognition,
context-aware question answering,
recognition of one or more objects left behind, or
suspicious activity monitoring.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center; or
a system implemented at least partially using cloud computing resources.

10. A method comprising:
based at least on a multi-modal language model generating one or more initial responses indicating a selected sensor of an ego-machine is relevant to a designated task, prompting the multi-modal language model to generate one or more subsequent responses evaluating the designated task based at least on one or more frames of sensor data generated using the selected sensor and applied to the multi-modal language model; and
controlling one or more operations of the ego-machine based at least on the one or more subsequent responses.

11. The method of claim 10, further comprising increasing an input resolution of at least one frame of one or more frames of the sensor data applied to the multi-modal language model based at least on the multi-modal language model generating the one or more initial responses indicating the selected sensor.

12. The method of claim 10, further comprising prompting the multi-modal language model to generate the one or more initial responses based at least on at least one first frame of one or more frames of the sensor data, and prompting the multi-modal language model to generate the one or more subsequent responses based at least on at least one second frame of the one or more frames the sensor data, the at least one first frame having a first resolution and the at least one second frame having a second resolution that is higher than the first resolution.

13. The method of claim 10, further comprising increasing a rate of providing prompts to the multi-modal language model based at least on the multi-modal language model generating the one or more initial responses identifying the selected sensor.

14. The method of claim 10, further comprising providing a prompt to the multi-modal language model to generate the one or more initial responses representative of the selected sensor based at least on applying at least one of:
a tiled representation of a plurality of frames of sensor data generated using a plurality of sensors of the ego-machine to the multi-modal language model; or
one or more compressed representations of a plurality of frames of sensor data generated using a plurality of sensors of the ego-machine to the multi-modal language model.

15. The method of claim 10, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center; or
a system implemented at least partially using cloud computing resources.

16. A system comprising one or more processors to control, within a simulation of an environment that is rendered using one or more light transport simulation algorithms, one or more operations of a simulated ego-machine in the simulated environment based at least on one or more outputs of one or more multi-modal language models, the one or more outputs generated based at least on the multi-modal language model evaluating whether one or more conditions associated with a designated task are present in one or more frames of simulated sensor data generated using a selected simulated sensor, the selected simulated sensor being selected from a plurality of simulated sensors based at least on the multi-modal language model evaluating a plurality of frames of simulated sensor data generated using the plurality of simulated sensors of the simulated ego-machine.

17. The system of claim 16, wherein the simulation is generated, at least in part, using a three-dimensional (3D) content collaboration platform for 3D assets.

18. The system of claim 17, wherein one or more files of the 3D content collaboration platform for 3D assets uses an OpenUSD format.

19. The system of claim 16, wherein the evaluating whether one or more conditions associated with a designated task are present in one or more frames of simulated sensor data comprises providing one or more text prompts to the multi-modal language model to generate one or more responses to evaluate a presence of the one or more conditions associated with the designated task based at least on one or more frames of generated simulated sensor data corresponding to the selected simulated sensor.

20. The system of claim 16, wherein at least one multi-modal language model of the one or more multi-modal language models is implemented in at least one processing node of a plurality of processing nodes of a data center and accessible to one or more remote clients via at least one of an application programming interface (API), or an application plug-in.
